(19) United States
(12) Patent Application Publication
(10) Pub. No.: US 2025/0199269 A1
(43) Pub. Date: Jun. 19, 2025

(54) OPTICAL IMAGING SYSTEM

(71) Applicant: Samsung Electro-Mechanics Co., Ltd., Suwon-si (KR)

(72) Inventors: Seong Il CHO, Suwon-si (KR); Hag Chul KIM, Suwon-si (KR); Do Hyeong JANG, Suwon-si (KR)

(73) Assignee: Samsung Electro-Mechanics Co., Ltd., Suwon-si (KR)

(21) Appl. No.: 18/819,636

(22) Filed: Aug. 29, 2024

(30) Foreign Application Priority Data
Dec. 19, 2023 (KR) 10-2023-0185910

(51) Int. Cl. G02B 13/00; G02B 9/62

(52) U.S. Cl. CPC G02B 13/0045; G02B 9/62

(57) ABSTRACT

An optical imaging system includes a first lens group including a first lens, a second lens, and a third lens, and a second lens group including a fourth lens, a fifth lens, and a sixth lens and configured to be movable in an optical axis direction, wherein the first lens group and the second lens group are disposed in order from an object side toward an image plane side, and wherein conditional expression 1.50<(v1−v2)/(v3−v2)<2.50 is satisfied, where v1 is an Abbe number of the first lens, v2 is an Abbe number of the second lens, and v3 is an Abbe number of the third lens.

### CROSS-REFERENCE TO RELATED APPLICATIONS

This application claims the benefit under 35 USC 119 (a) of Korean Patent Application No. 10-2023-0185910 filed on Dec. 19, 2023, in the Korean Intellectual Property Office, the entire disclosure of which is incorporated herein by reference for all purposes.

### BACKGROUND

### 1. Field

The present disclosure relates to an optical imaging system employed in a mobile device.

### 2. Description of the Background

Among the various types of cameras employed in a mobile device, a telephoto camera having a long focal length may be used to image a subject disposed at a long distance or a mid-distance, and a wide-angle camera may be used when obtaining an image of a subject disposed at a short distance or an ultra-short distance.

A telephoto camera used in a general mobile device may be configured to bend a path of incident light using a reflective member disposed therein to form a long focal length in a limited space. In this structure, a size (height) of the image sensor may affect a thickness of the mobile device, such that the image sensor may be slimmed by using a relatively small-sized image sensor, but the number of pixels in the image sensor may be low, which may be disadvantageous in securing resolution. However, a large-sized image sensor may be used in a camera for mobile device, and also in a telephoto camera.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including a first lens, a second lens, and a third lens, and a second lens group including a fourth lens, a fifth lens, and a sixth lens and configured to be movable in an optical axis direction, wherein the first lens group and the second lens group are disposed in order from an object side toward an image plane side, and wherein conditional expression 1.50<(v1−v2)/(v3−v2)<2.50 is satisfied, where v1 is an Abbe number of the first lens, v2 is an Abbe number of the second lens, and v3 is an Abbe number of the third lens.

The first lens may be formed of a glass material, the first lens may have positive refractive power, and the second lens may have negative refractive power.

The third lens may have positive refractive power, and both an object-side surface and an image-side surface of the third lens may be convex.

Conditional expression −1.50<f2/fG1<−0.85 may be satisfied, where f2 is a focal length of the second lens, and fG1 is a focal length of the first lens group.

Conditional expression 0.38<CT1/ΣCTG1≤0.60 may be satisfied, where CT1 is a central thickness of the first lens, and ΣCTG1 is a sum of central thicknesses of the lenses included in the first lens group.

Conditional expression 2.00<Fno≤2.60 may be satisfied, where Fno is an f value of the optical imaging system.

The fourth lens may have negative refractive power and a convex object-side surface.

The fifth lens may have positive refractive power, and the sixth lens may have negative refractive power.

Conditional expression 0.30≤v5/v6<1.20 may be satisfied, where v5 is an Abbe number of the fifth lens, and v6 is an Abbe number of the sixth lens.

Conditional expression 0.35<EPD/TTL≤0.40 may be satisfied, where EPD is an entrance pupil diameter of the optical imaging system, and TTL is a distance on the optical axis from an object-side surface of the first lens to the image plane.

In another general aspect, an optical imaging system includes a first lens group including a plurality of lenses and disposed fixedly on an optical axis, and a second lens group including a plurality of lenses and configured to be movable in an optical axis direction between the first lens group and an image plane, wherein the first lens group and the second lens group are disposed in order from an object side toward the image plane side, wherein conditional expression 0.35<EPD/TTL≤0.40 is satisfied, where EPD is an entrance pupil diameter of the optical imaging system, and TTL is a distance on the optical axis from an object-side surface of a lens disposed closest to the object side among the plurality of lenses to the image plane.

The first lens group may have positive refractive power, and the second lens group may have negative refractive power.

The first lens group may include a lens formed of a glass material.

Conditional expression 0.95≤TTL/f<1.10 may be satisfied, where TTL is a distance on the optical axis from an object-side surface of a lens disposed closest to the object side to the image plane, and f is a focal length of the optical imaging system.

Conditional expression 0.30<BFL/f<0.50 may be satisfied, where BFL is a distance on the optical axis from an image-side surface of a lens disposed closest to the image side to the image plane, and f is a focal length of the optical imaging system.

The first lens group may include a first lens having positive refractive power, a second lens having negative refractive power, and a third lens having positive refractive power, and the second lens group may include a fourth lens having negative refractive power, a fifth lens having positive refractive power, and a sixth lens having negative refractive power.

In another general aspect, an optical imaging system includes a first lens group including a first lens, a second lens, and a third lens, and a second lens group including a fourth lens, a fifth lens, and a sixth lens and configured to be movable in an optical axis direction, wherein the first lens group and the second lens group are disposed in order from an object side toward an image plane, wherein conditional expressions 0.30<BFL/f<0.50, and 2.00<Fno≤2.60 are satisfied, where BFL is a distance on the optical axis from an image-side surface of the sixth lens to the image plane, f is a focal length of the optical imaging system, and Fno is an f value of the optical imaging system.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph indicating aberration properties of an optical imaging system according to a first embodiment of the present disclosure.

FIG. 2A is a configuration diagram illustrating an optical imaging system according to a second embodiment of the present disclosure.

FIG. 2B is a graph indicating aberration properties of an optical imaging system according to a second embodiment of the present disclosure.

FIG. 3A is a configuration diagram illustrating an optical imaging system according to a third embodiment of the present disclosure.

FIG. 3B is a graph indicating aberration properties of an optical imaging system according to a third embodiment of the present disclosure.

FIG. 4A is a configuration diagram illustrating an optical imaging system according to a fourth embodiment of the present disclosure.

FIG. 4B is a graph indicating aberration properties of an optical imaging system according to a fourth embodiment of the present disclosure.

FIG. 5A is a configuration diagram illustrating an optical imaging system according to a fifth embodiment of the present disclosure.

FIG. 5B is a graph indicating aberration properties of an optical imaging system according to a fifth embodiment of the present disclosure.

FIG. 6A is a configuration diagram illustrating an optical imaging system according to a sixth embodiment of the present disclosure.

FIG. 6B is a graph indicating aberration properties of an optical imaging system according to a sixth embodiment of the present disclosure.

FIG. 7A is a configuration diagram illustrating an optical imaging system according to a seventh embodiment of the present disclosure.

FIG. 7B is a graph indicating aberration properties of an optical imaging system according to a seventh embodiment of the present disclosure.

FIG. 8A is a configuration diagram illustrating an optical imaging system according to an eighth embodiment of the present disclosure.

FIG. 8B is a graph indicating aberration properties of an optical imaging system according to an eighth embodiment of the present disclosure.

FIG. 9A is a configuration diagram illustrating an optical imaging system according to a ninth embodiment of the present disclosure.

FIG. 9B is a graph indicating aberration properties of an optical imaging system according to a ninth embodiment of the present disclosure.

FIG. 10A is a configuration diagram illustrating an optical imaging system according to a tenth embodiment of the present disclosure.

FIG. 10B is a graph indicating aberration properties of an optical imaging system according to a tenth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system which may obtain an image at an ultra-short distance and may ensure uniform resolution without being affected by a focal length.

In embodiments, a unit of values of radius of curvature, thickness, distance, focal length, ½ of a diagonal length of an image plane (IMG HT), and semi-aperture of a lens may be millimeter (mm), and a unit of a field of view (FOV) may be degree. Also, a thickness of a lens and a distance between lenses may refer to a thickness and a distance on an optical axis.

In embodiments, an object side may indicate a direction in which an object is disposed, and an image side may indicate, for example, a direction in which an image plane on which an image is formed is disposed or a direction in which an image sensor is disposed.

In the description related to the shape of a lens of the embodiments, a convex surface may indicate that a paraxial region (a narrow region in vicinity of and including an optical axis) portion of a surface may be convex, and a concave surface may indicate that a paraxial region portion of the surface may be concave. Accordingly, even when one surface of the lens is described as being convex, an edge portion of the lens may be concave. Similarly, although one surface of a lens is described as being concave, an edge portion of the lens may be convex.

An optical imaging system according to embodiments may be employed in a camera of a mobile device. For example, a mobile device may be implemented as any type of portable electronic device, such as a mobile communication terminal, smart phone, or tablet PC.

According to embodiments, an optical imaging system may include six lenses. For example, the optical imaging system may include a first lens, a second lens, a third lens, a fourth lens, a fifth lens, and a sixth lens disposed in order from an object side.

The optical imaging system according to embodiments may not only include a plurality of lenses, but may further include an image sensor configured to convert incident light into an electrical signal, an infrared cut-off filter configured to block light in the infrared region incident to the image sensor, and an aperture configured to control the amount of incident light.

In embodiments, six lenses may be included in a first lens group and a second lens group. For example, the first to third lens may be included in the first lens group, and the fourth to sixth lens may be included in the second lens group.

The first lens group may be configured as a fixed lens group of which a position in the optical axis direction is fixed, and the second lens group may be configured as a moving lens group (or a focusing lens group) configured to move in the optical axis direction. The second lens group may move in the optical axis direction between the first lens group and an image plane. For example, the second lens group may move in a direction away from the first lens group.

In embodiments, the optical imaging system may obtain an image of a subject disposed at a long distance or a mid-distance when the second lens group is disposed closest to the first lens group (or first position), and may obtain an image of a subject disposed at an ultra-short distance when the second lens group is disposed farthest from the first lens group (or second position).

Since the first lens group is a fixed lens group and the position of the first lens group with respect to the image sensor does not change, even when the second lens group moves, the total track length (TTL) of the optical imaging system may be constant.

In embodiments, the six lenses may be formed of glass or a plastic material. For example, the first lens may be formed of a glass material, and the second lens to sixth lens may be formed of a plastic material.

In embodiments, the six lenses may be spherical or aspherical lenses. For example, at least one of an object-side surface and an image-side surface of the first lens may be spherical, and at least one of an object-side surface and an image-side surface of each of the second to sixth lenses may be aspherical. The aspherical properties of a lens may be represented by equation 1.

$$Equation 1$$

$$Z = \frac{{cY}^{2}}{1 + \sqrt{1 - ( 1 + k ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30}$$

In equation 1, c may be the reciprocal of a radius of curvature of the lens, K may be the conic constant, and Y may be the distance from a point on the aspherical surface of the lens to the optical axis. Also, constants A-H, J, and L-P may be aspherical constants from the 4th to the 30th order, and Z (or SAG) is the distance in the optical axis direction between a point on the aspherical surface and the apex of the aspherical surface.

In embodiments, the optical imaging system may satisfy conditional expressions as below.

$$1.5 < ( v 1 - v 2 ) / ( v 3 - v 2 ) < 2.5 \qquad [ Conditional expression 1 ]$$

$$0.3 \leq v 5 / v 6 < 1.2 \qquad [ Conditional expression 2 ]$$

$$- 1.5 < f 2 / fG 1 < - 0.85 \qquad [ Conditional expression 3 ]$$

$$0.95 \leq TTL / f < 1.1 \qquad [ Conditional expression 4 ]$$

$$0.3 < BFL / f < 0.5 \qquad [ Conditional expression 5 ]$$

$$0.35 < EPD / TTL \leq 0.4 \qquad [ Conditional expression 6 ]$$

$$2. < Fno \leq 2.6 \qquad [ Conditional expression 7 ]$$

$$0.35 < CT 1 / \sum CTG 1 \leq 0.65 \qquad [ Conditional expression 8 ]$$

$$0.5 \leq SDG 2 / ImgHT \leq 0.8 \qquad [ Conditional expression 9 ]$$

$$0.2 < StrokeG 2 / BFL < 0.45 \qquad [ Conditional expression 10 ]$$

In Conditional expression 1, v1 is the Abbe number of the first lens, v2 is the Abbe number of the second lens, and v3 is the Abbe number of the third lens. Conditional expression 1 may be related to the lens material arrangement of the first lens group which may efficiently reduce chromatic aberration of the optical imaging system according to embodiments. In embodiments, by forming the first lens having relatively strong positive power with a low-dispersion material, a difference in refractive indexes of different wavelengths may be reduced.

In Conditional expression 2, v5 is the Abbe number of the fifth lens, and v6 is the Abbe number of the sixth lens. Conditional expression 2 may be related to the lens material arrangement of the second lens group which may efficiently reduce chromatic aberration of the optical imaging system according to embodiments. In embodiments, by disposing two materials having different dispersion rates in order, chromatic aberration may be reduced.

In Conditional expression 3, f2 is the focal length of the second lens, and fG1 is the focal length of the first lens group. Conditional expression 3 may be related to a lens power arrangement which may efficiently reduce aberration in the first lens group in the optical imaging system according to embodiments. In embodiments, by alternately disposing lenses having positive power and lenses having negative power in the first lens group, aberration in the first lens group may be efficiently reduced.

In Conditional expression 4, TTL is the distance on the optical axis from an object-side surface of the first lens to the image plane, and f is the focal length of the optical imaging system. Conditional expression 4 may represent the telephoto ratio of the optical imaging system according to embodiments, and when the ratio is beyond the range of the conditional expression (especially a lower limit), it may be difficult to ensure telephoto performance.

In Conditional expression 5, BFL is the distance on the optical axis from an image-side surface of the sixth lens to the image plane, and f is the focal length of the optical imaging system. Conditional expression 5 may be related to the AF stroke amount (range) of the second lens group of the optical imaging system according to embodiments.

In Conditional expression 6], EPD is the entrance pupil diameter of the optical imaging system, and TTL is the distance on the optical axis from an object-side surface of the first lens to the image plane. Conditional expression 6 may be related to brightness performance of the optical imaging system according to embodiments. In embodiments, as the EPD increases as compared to TTL, the optical imaging system may have increased brightness.

In Conditional expression 7, Fno is the f value (f number) of the optical imaging system. Conditional expression 7 may be related to brightness performance of the optical imaging system according to embodiments.

In Conditional expression 8, CT1 is the central thickness (thickness on the optical axis) of the first lens, and ΣCTG1 is the sum of the central thicknesses (thicknesses on the optical axis) of the lenses included in the first lens group. Conditional expression 8 may be related to reliability of lens according to embodiments, and by increasing the thickness of the first lens formed of a glass material, reliability may be ensured.

In Conditional expression 9, SDG2 is the maximum effective diameter of the second lens group, and ImgHT is half the diagonal length of the image sensor. Conditional expression 9 may be related to the size of the image sensor according to embodiments. In embodiments, once the size of the image sensor and the focal length of the optical imaging system are determined, the maximum effective diameter of the second lens group may be determined to satisfy the range of Conditional expression 9.

In Conditional expression 10, StrokeG2 is the amount of maximum movement (infinite focal length-minimum focal length) of the second lens group, and BFL is the distance on the optical axis from an image-side surface of the sixth lens to the image plane. Conditional expression 10 may be related to the AF stroke of a telephoto macro camera according to the embodiments, and by determining the BFL to satisfy the range of Conditional expression 10 depending on the stroke amount, an actuator space may be sufficiently ensured.

Hereinafter, an optical imaging system according to embodiments may be described with reference to the attached drawings.

### First Embodiment

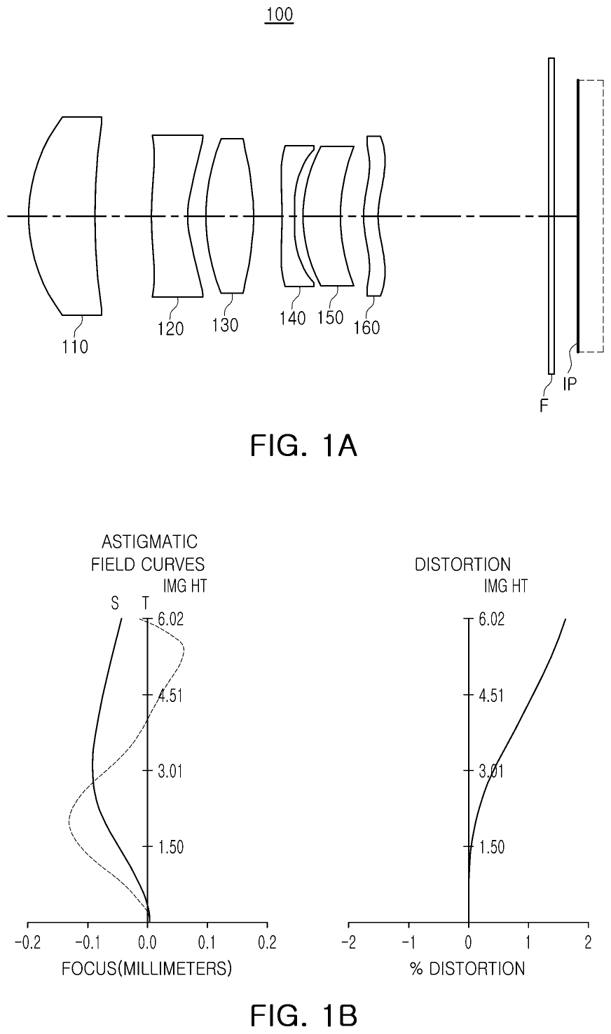

FIG. 1A is a configuration diagram illustrating an optical imaging system according to a first embodiment. FIG. 1B is a graph indicating aberration properties of an optical imaging system according to a first embodiment.

According to the first embodiment, an optical imaging system 100 may include a first lens 110, a second lens 120, a third lens 130, a fourth lens 140, a fifth lens 150, and a sixth lens 160 disposed in order from an object side, and may further include an infrared cut-off filter F and an image sensor IP disposed on an image side of the sixth lens 160. Also, the optical imaging system 100 may further include an aperture ST disposed on an object side of the third lens 130.

The first lens 110 may have positive refractive power. An object-side surface of the first lens 110 may be convex in a paraxial region, and an image-side surface of the first lens 110 may be concave in the paraxial region. The first lens 110 may be formed of a (low dispersion) glass material. Also, the first lens 110 may be a spherical lens. For example, an object-side surface and an image-side surface of the first lens 110 may be spherical.

The second lens 120 may have negative refractive power. An object-side surface of the second lens 120 may be convex in a paraxial region, and an image-side surface of the second lens 120 may be concave in the paraxial region. The second lens 120 may be formed of a plastic material. Accordingly, the second lens 120 may have different optical properties (e.g., different refractive indices and different Abbe numbers) from those of the first lens 110. Also, the second lens 120 may be an aspherical lens. For example, an object-side surface and an image-side surface of the second lens 120 may be aspherical.

The third lens 130 may have positive refractive power. Both an object-side surface and an image-side surface of the third lens 130 may be convex in a paraxial region. The third lens 130 may be formed of a plastic material. For example, the third lens 130 may be formed of a plastic material having different optical properties (e.g., a different refractive index and a different Abbe number) from those of the second lens 120, and may be formed of a plastic material having an Abbe number higher than that of the second lens 120. Also, the third lens 130 may be an aspherical lens. For example, an object-side surface and an image-side surface of the third lens 130 may be aspherical.

The fourth lens 140 may have negative refractive power. Both an object-side surface and an image-side surface of the fourth lens 140 may be concave in a paraxial region. The fourth lens 140 may be formed of a plastic material. For example, the fourth lens 140 may be formed of a plastic material having optical properties the same as or similar to (e.g., the same or a similar refractive index and Abbe number) those of the third lens 130, and may be formed of a plastic material having an Abbe number higher than that of the fifth lens 150. Also, the fourth lens 140 may be an aspherical lens. For example, an object-side surface and an image-side surface of the fourth lens 140 may be aspherical.

The fifth lens 150 may have positive refractive power. An object-side surface of the fifth lens 150 may be convex in a paraxial region, and an image-side surface of the fifth lens 150 may be concave in the paraxial region. The fifth lens 150 may be formed of a plastic material. For example, the fifth lens 150 may be formed of a plastic material having different optical properties (e.g., a different refractive index and a different Abbe number) from those of the fourth lens 140. Also, the fifth lens 150 may be an aspherical lens. For example, an object-side surface and an image-side surface of the fifth lens 150 may be aspherical.

The sixth lens 160 may have negative refractive power. An object-side surface of the sixth lens 160 may be convex in a paraxial region, and an image-side surface of the sixth lens 160 may be concave in the paraxial region. The sixth lens 160 may be formed of a plastic material. For example, the sixth lens 160 may be formed of a plastic material having different optical properties (e.g., a different refractive index and a different Abbe number) from those of the fifth lens 150. Also, the sixth lens 160 may be an aspherical lens. For example, an object-side surface and an image-side surface of the sixth lens 160 may be aspherical.

According to the first embodiment, the optical imaging system 100 may include a first lens group LG1 including the first lens 110, the second lens 120 and the third lens 130, and a second lens group LG2 including the fourth lens 140, the fifth lens 150 and the sixth lens 160. The second lens group LG2 may move toward the image plane IP side when obtaining an image of a subject disposed at an ultra-short distance.

Table 1 below indicates optical and physical parameters of the optical imaging system 100 according to the first embodiment.

TABLE 1

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.4859 | 2.8000 | 1.4370 | 95.10 | 4.40 |
| 3 | 32.0469 | 2.3500 | | | 4.08 |
| 4 | 13.5909 | 1.5285 | 1.6144 | 25.94 | 3.61 |
| 5 | 5.2092 | 0.7664 | | | 3.46 |
| 6 | 8.1176 | 2.0000 | 1.5349 | 55.74 | 3.44 |
| 7 | −11.4019 | D1 | | | 3.30 |
| 8 | −10.2845 | 0.5000 | 1.5440 | 55.99 | 3.13 |
| 9 | 21.5151 | 0.3708 | | | 2.96 |
| 10 | 6.9614 | 1.5495 | 1.6608 | 20.38 | 3.05 |
| 11 | 7.6989 | 0.9796 | | | 3.11 |
| 12 | 4.2359 | 0.6000 | 1.5349 | 55.74 | 3.32 |
| 13 | 3.9054 | D2 | | | 3.54 |
| 14 | Infinity | 0.2100 | 1.5168 | 64.20 | 7.00 |
| 15 | Infinity | 1.0000 | | | 7.00 |
| Image | Infinity | | | | |

Table 2 below indicates aspherical data of the optical imaging system 100 according to the first embodiment.

TABLE 2

| Surface | 2 | 3 | 4 | 5 | 6 | 7 |
|---|---|---|---|---|---|---|
| K | 0.00E+00 | 0.00E+00 | −1.72E+01 | −9.35E+00 | 0.00E+00 | 0.00E+00 |
| A | 0.00E+00 | 0.00E+00 | −2.87E−03 | 2.32E−03 | −1.69E−03 | −1.40E−04 |
| B | 0.00E+00 | 0.00E+00 | 2.70E−04 | −7.87E−04 | 3.11E−04 | 3.67E−04 |
| C | 0.00E+00 | 0.00E+00 | −8.36E−05 | 1.08E−04 | −1.39E−04 | −1.80E−04 |
| D | 0.00E+00 | 0.00E+00 | 1.87E−05 | −1.10E−05 | 3.92E−05 | 5.83E−05 |
| E | 0.00E+00 | 0.00E+00 | −2.73E−06 | 4.06E−07 | −7.49E−06 | −1.17E−05 |
| F | 0.00E+00 | 0.00E+00 | 2.58E−07 | 7.80E−08 | 9.24E−07 | 1.45E−06 |
| G | 0.00E+00 | 0.00E+00 | −1.52E−08 | −1.18E−08 | −6.80E−08 | −1.07E−07 |
| H | 0.00E+00 | 0.00E+00 | 4.99E−10 | 6.25E−10 | 2.70E−09 | 4.31E−09 |
| J | 0.00E+00 | 0.00E+00 | −6.99E−12 | −1.21E−11 | −4.48E−11 | −7.32E−11 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −1.86E+01 | −9.00E+01 | −1.37E+00 | −1.02E+00 | 0.00E+00 | −5.93E+00 |
| A | 1.61E−02 | 2.08E−02 | 2.31E−03 | −4.25E−03 | −2.39E−02 | −1.18E−02 |
| B | −4.54E−03 | −3.58E−03 | −3.83E−04 | 2.33E−03 | 2.87E−03 | 1.76E−03 |
| C | 1.04E−03 | −5.53E−04 | −2.74E−04 | −9.68E−04 | −4.56E−04 | −4.75E−04 |
| D | −1.27E−04 | 6.35E−04 | 1.51E−04 | 2.64E−04 | 4.44E−05 | 1.11E−04 |
| E | 9.42E−08 | −1.93E−04 | −3.27E−05 | −4.42E−05 | 2.92E−06 | −1.71E−05 |
| F | 2.20E−06 | 3.13E−05 | 3.65E−06 | 4.38E−06 | −1.45E−06 | 1.67E−06 |
| G | −2.98E−07 | −2.90E−06 | −2.04E−07 | −2.36E−07 | 1.72E−07 | −1.01E−07 |
| H | 1.71E−08 | 1.45E−07 | 4.23E−09 | 5.48E−09 | −9.05E−09 | 3.45E−09 |
| J | −3.81E−10 | −3.03E−09 | 2.33E−11 | −1.44E−11 | 1.81E−10 | −5.19E−11 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Second Embodiment

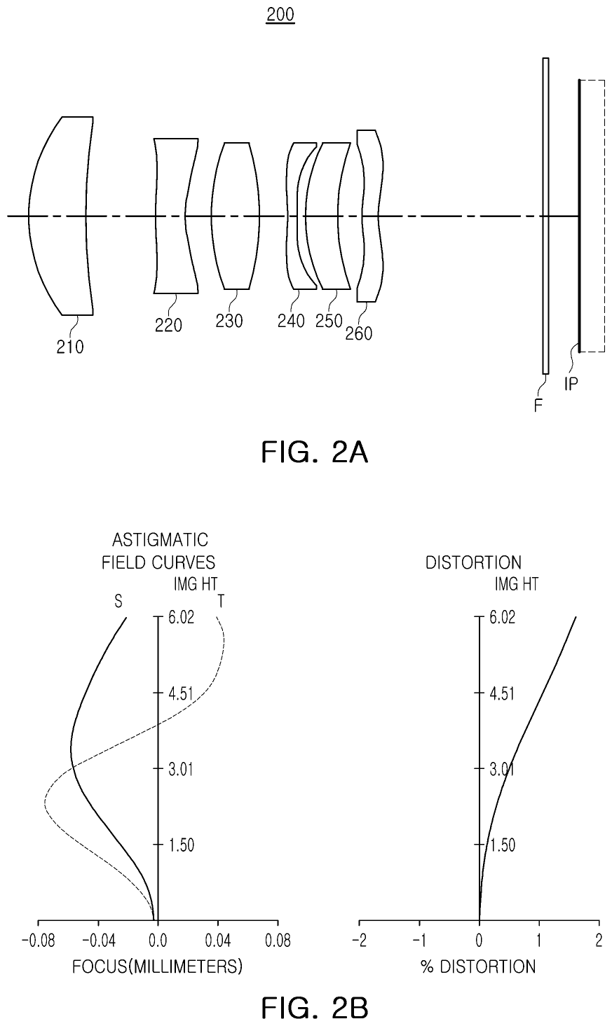

FIG. 2A is a configuration diagram illustrating an optical imaging system according to a second embodiment. FIG. 2B is a graph indicating aberration properties of an optical imaging system according to a second embodiment.

According to the second embodiment, the optical imaging system 200 may include a first lens 210, a second lens 220, a third lens 230, a fourth lens 240, a fifth lens 250, and a sixth lens 260 disposed in order from an object side, and may further include an infrared cut-off filter F and an image sensor IP disposed on an image side of the sixth lens 260. Also, the optical imaging system 200 may further include an aperture ST disposed on an object side of the third lens 230.

The first lens 210 may have positive refractive power. An object-side surface of the first lens 210 may be convex in a paraxial region, and an image-side surface of the first lens 210 may be concave in the paraxial region. The first lens 210 may be formed of a (low dispersion) glass material. Also, the first lens 210 may be a spherical lens. For example, an object-side surface and an image-side surface of the first lens 210 may be spherical.

The second lens 220 may have negative refractive power. An object-side surface of the second lens 220 may be convex in a paraxial region, and an image-side surface of the second lens 220 may be concave in the paraxial region. The second lens 220 may be formed of a plastic material. Accordingly, the second lens 220 may have different optical properties (e.g., a different refractive index and a different Abbe number) from those of the first lens 210. Also, the second lens 220 may be an aspherical lens. For example, an object-side surface and an image-side surface of the second lens 220 may be aspherical.

The third lens 230 may have positive refractive power. Both an object-side surface and an image-side surface of the third lens 230 may be convex in a paraxial region. The third lens 230 may be formed of a plastic material. For example, the third lens 230 may be formed of a plastic material having different optical properties (e.g., a different refractive index and a different Abbe number) from those of the second lens 220, and may be formed of a plastic material having an Abbe number higher than that of the second lens 220. Also, the third lens 230 may be an aspherical lens. For example, an object-side surface and an image-side surface of the third lens 230 may be aspherical.

The fourth lens 240 may have negative refractive power. An object-side surface of the fourth lens 240 may be concave in a paraxial region, and an image-side surface of the fourth lens 240 may be convex in the paraxial region. The fourth lens 240 may be formed of a plastic material. For example, the fourth lens 240 may be formed of a plastic material having optical properties the same as or similar to (e.g., the same or a similar refractive index and Abbe number) those of the third lens 230, and may be formed of a plastic material having an Abbe number higher than that of the fifth lens 250. Also, the fourth lens 240 may be an aspherical lens. For example, an object-side surface and an image-side surface of the fourth lens 240 may be aspherical.

The fifth lens 250 may have positive refractive power. An object-side surface of the fifth lens 250 may be convex in a paraxial region, and an image-side surface of the fifth lens 250 may be concave in the paraxial region. The fifth lens 250 may be formed of a plastic material. For example, the fifth lens 250 may be formed of a plastic material having different optical properties (e.g., a different refractive index and a different Abbe number) from those of the fourth lens 240. Also, the fifth lens 250 may be an aspherical lens. For example, an object-side surface and an image-side surface of the fifth lens 250 may be aspherical.

The sixth lens 260 may have negative refractive power. An object-side surface of the sixth lens 260 may be convex in a paraxial region, and an image-side surface of the sixth lens 260 may be concave in the paraxial region. The sixth lens 260 may be formed of a plastic material. For example, the sixth lens 260 may be formed of a plastic material having different optical properties (e.g., a different refractive index and a different Abbe number) from those of the fifth lens 250. Also, the sixth lens 260 may be an aspherical lens. For example, an object-side surface and an image-side surface of the sixth lens 260 may be aspherical.

According to the second embodiment, the optical imaging system 200 may include a first lens group LG1 including the first lens 210, the second lens 220 and the third lens 230, and a second lens group LG2 including the fourth lens 240, the fifth lens 250 and the sixth lens 260. The second lens group LG2 may move toward the image plane IP side when obtaining an image of a subject disposed at an ultra-short distance.

Table 3 below indicates optical and physical parameters of the optical imaging system 200 according to the second embodiment.

TABLE 3

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.6910 | 2.4000 | 1.4970 | 81.61 | 4.40 |
| 3 | 28.8302 | 2.8903 | | | 4.11 |
| 4 | 17.2507 | 1.2400 | 1.6144 | 25.94 | 3.45 |
| 5 | 5.3830 | 1.0697 | | | 3.30 |
| 6 | 7.8152 | 2.0000 | 1.5349 | 55.74 | 3.25 |
| 7 | −12.0673 | D1 | | | 3.22 |
| 8 | −6.9357 | 0.4000 | 1.5440 | 55.99 | 3.25 |
| 9 | −33.5887 | 0.3259 | | | 3.04 |
| 10 | 6.7952 | 1.3555 | 1.6608 | 20.38 | 3.25 |
| 11 | 7.7674 | 1.0310 | | | 3.19 |
| 12 | 6.8469 | 0.6876 | 1.5349 | 55.74 | 3.30 |
| 13 | 5.1558 | D2 | | | 3.80 |
| 14 | Infinity | 0.2100 | 1.5168 | 64.20 | 7.00 |
| 15 | Infinity | 1.3224 | | | 7.00 |
| Image | Infinity | | | | |

Table 4 below indicates aspherical data of the optical imaging system 200 according to the second embodiment.

TABLE 4

| Surface | 2 | 3 | 4 | 5 | 6 | 7 |
|---|---|---|---|---|---|---|
| K | 0.00E+00 | 0.00E+00 | −5.56E+01 | −1.07E+01 | 0.00E+00 | 0.00E+00 |
| A | 0.00E+00 | 0.00E+00 | −3.17E−03 | 2.04E−03 | −9.46E−04 | 4.52E−04 |
| B | 0.00E+00 | 0.00E+00 | 7.71E−05 | −1.05E−03 | −5.24E−05 | 4.04E−06 |
| C | 0.00E+00 | 0.00E+00 | 3.58E−06 | 2.11E−04 | 1.97E−06 | −1.26E−06 |
| D | 0.00E+00 | 0.00E+00 | −1.99E−06 | −3.08E−05 | 4.25E−08 | 8.52E−08 |
| E | 0.00E+00 | 0.00E+00 | 5.81E−07 | 3.12E−06 | 0.00E+00 | 0.00E+00 |
| F | 0.00E+00 | 0.00E+00 | −8.97E−08 | −1.92E−07 | 0.00E+00 | 0.00E+00 |
| G | 0.00E+00 | 0.00E+00 | 7.55E−09 | 5.09E−09 | 0.00E+00 | 0.00E+00 |
| H | 0.00E+00 | 0.00E+00 | −3.30E−10 | 7.28E−11 | 0.00E+00 | 0.00E+00 |
| J | 0.00E+00 | 0.00E+00 | 5.88E−12 | −5.36E−12 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −2.44E+01 | −8.70E+01 | −2.00E+00 | −2.44E+00 | 0.00E+00 | −5.87E+00 |
| A | 2.04E−02 | 2.98E−02 | 1.30E−03 | −4.67E−03 | −1.99E−02 | −1.37E−02 |
| B | −4.76E−03 | −5.41E−03 | −9.51E−05 | 2.00E−03 | 2.24E−03 | 1.63E−03 |
| C | 5.30E−04 | 5.69E−04 | −5.33E−04 | −9.19E−04 | −4.90E−04 | −2.40E−04 |
| D | 9.69E−05 | 6.78E−04 | 2.52E−04 | 2.91E−04 | 1.49E−04 | 4.42E−05 |
| E | −4.47E−05 | −1.87E−04 | −5.50E−05 | −5.86E−05 | −3.41E−05 | −7.00E−06 |
| F | 7.20E−06 | 2.78E−05 | 7.12E−06 | 7.80E−06 | 5.19E−06 | 7.59E−07 |
| G | −6.14E−07 | −2.42E−06 | −5.83E−07 | −6.79E−07 | −4.93E−07 | −5.21E−08 |
| H | 2.77E−08 | 1.19E−07 | 2.84E−08 | 3.50E−08 | 2.62E−08 | 2.04E−09 |
| J | −5.26E−10 | −2.54E−09 | −6.27E−10 | −7.95E−10 | −5.87E−10 | −3.45E−11 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Third Embodiment

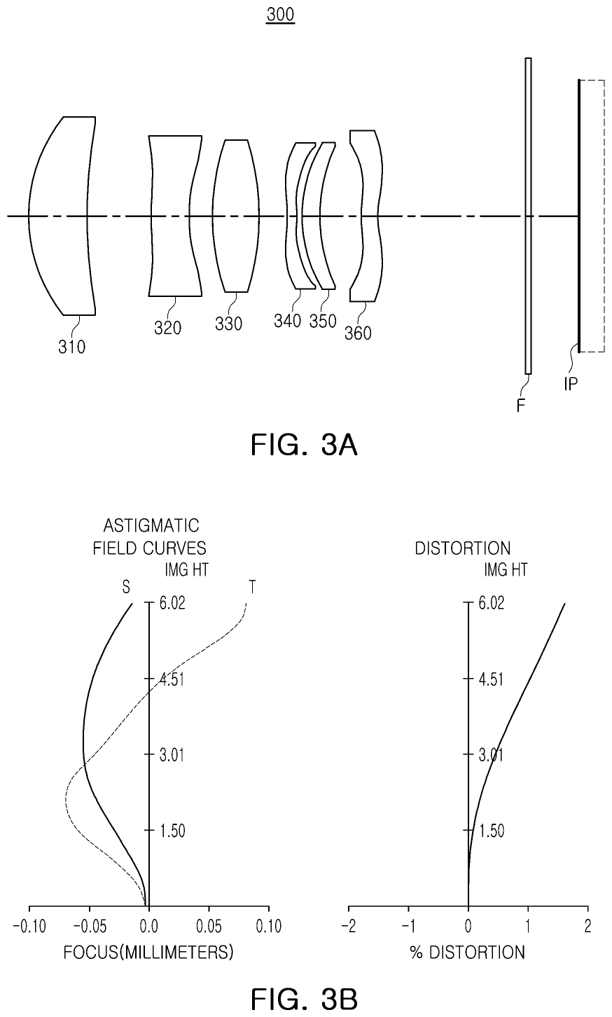

FIG. 3A is a configuration diagram illustrating an optical imaging system according to a third embodiment. FIG. 3B is a graph indicating aberration properties of an optical imaging system according to a third embodiment.

According to a third embodiment, an optical imaging system 300 may include a first lens 310, a second lens 320, a third lens 330, a fourth lens 340, a fifth lens 350, and a sixth lens 360 disposed in order from an object side, and may further include an infrared cut-off filter F and an image sensor IP disposed on an image side of the sixth lens 360. Also, the optical imaging system 300 may further include an aperture ST disposed on an object side of the third lens 330.

The first lens 310 may have positive refractive power. An object-side surface of the first lens 310 may be convex in a paraxial region, and an image-side surface of the first lens 310 may be concave in the paraxial region. The first lens 310 may be formed of a (low dispersion) glass material. Also, the first lens 310 may be a spherical lens. For example, an object-side surface and an image-side surface of the first lens 310 may be spherical.

The second lens 320 may have negative refractive power. An object-side surface of the second lens 320 may be convex in a paraxial region, and an image-side surface of the second lens 320 may be concave in the paraxial region. The second lens 320 may be formed of a plastic material. Accordingly, the second lens 320 may have different optical properties (e.g., a different refractive index and a different Abbe number) from those of the first lens 310. Also, the second lens 320 may be an aspherical lens. For example, an object-side surface and an image-side surface of the second lens 320 may be aspherical.

The third lens 330 may have positive refractive power. Both an object-side surface and an image-side surface of the third lens 330 may be convex in a paraxial region. The third lens 330 may be formed of a plastic material. For example, the third lens 330 may be formed of a plastic material having different optical properties (e.g., a different refractive index and a different Abbe number) from those of the second lens 320, and may be formed of a plastic material having an Abbe number higher than that of the second lens 320. Also, the third lens 330 may be an aspherical lens. For example, an object-side surface and an image-side surface of the third lens 330 may be aspherical.

The fourth lens 340 may have negative refractive power. An object-side surface of the fourth lens 340 may be concave in a paraxial region, and an image-side surface of the fourth lens 340 may be convex in the paraxial region. The fourth lens 340 may be formed of a plastic material. For example, the fourth lens 340 may be formed of a plastic material having optical properties the same as or similar to (e.g., the same or a similar refractive index and Abbe number) those of the third lens 330, and may be formed of a plastic material having an Abbe number higher than that of the fifth lens 350. Also, the fourth lens 340 may be an aspherical lens. For example, an object-side surface and an image-side surface of the fourth lens 340 may be aspherical.

The fifth lens 350 may have positive refractive power. An object-side surface of the fifth lens 350 may be convex in a paraxial region, and an image-side surface of the fifth lens 350 may be concave in the paraxial region. The fifth lens 350 may be formed of a plastic material. For example, the fifth lens 350 may be formed of a plastic material having different optical properties (e.g., a different refractive index and a different Abbe number) from those of the fourth lens 340. Also, the fifth lens 350 may be an aspherical lens. For example, an object-side surface and an image-side surface of the fifth lens 350 may be aspherical.

The sixth lens 360 may have negative refractive power. An object-side surface of the sixth lens 360 may be convex in a paraxial region, and an image-side surface of the sixth lens 360 may be concave in the paraxial region. The sixth lens 360 may be formed of a plastic material. For example, the sixth lens 360 may be formed of a plastic material having different optical properties (e.g., a different refractive index and a different Abbe number) from those of the fifth lens 350. Also, the sixth lens 360 may be an aspherical lens. For example, an object-side surface and an image-side surface of the sixth lens 360 may be aspherical.

According to the third embodiment, the optical imaging system 300 may include a first lens group LG1 including the first lens 310, the second lens 320 and the third lens 330, and a second lens group LG2 including the fourth lens 340, the fifth lens 350 and the sixth lens 360. The second lens group LG2 may move toward the image plane IP side when obtaining an image of a subject disposed at an ultra-short distance.

Table 5 below indicates optical and physical parameters of the optical imaging system 300 according to the third embodiment.

TABLE 5

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.3821 | 2.4290 | 1.4565 | 90.27 | 4.40 |
| 3 | 23.2197 | 2.7021 | | | 4.10 |
| 4 | 22.5555 | 1.5808 | 1.6144 | 25.94 | 3.57 |
| 5 | 5.9127 | 0.8882 | | | 3.41 |
| 6 | 7.7486 | 2.0000 | 1.5349 | 55.74 | 3.40 |
| 7 | −11.1189 | D1 | | | 3.27 |
| 8 | −8.4742 | 0.4000 | 1.5440 | 55.99 | 3.25 |
| 9 | −38.4327 | 0.2254 | | | 3.11 |
| 10 | 5.0323 | 0.7511 | 1.6608 | 20.38 | 3.25 |
| 11 | 5.5767 | 1.7369 | | | 3.13 |
| 12 | 8.5245 | 0.6867 | 1.5349 | 55.74 | 3.30 |
| 13 | 5.1353 | D2 | | | 3.80 |
| 14 | Infinity | 0.2100 | 1.5168 | 64.20 | 7.00 |
| 15 | Infinity | 1.9794 | | | 7.00 |
| Image | Infinity | | | | |

Table 6 below indicates aspherical data of the optical imaging system 300 according to the third embodiment.

TABLE 6

| Surface | 2 | 3 | 4 | 5 | 6 | 7 |
|---|---|---|---|---|---|---|
| K | 0.00E+00 | 0.00E+00 | −2.97E+01 | −1.11E+01 | 0.00E+00 | 0.00E+00 |
| A | 0.00E+00 | 0.00E+00 | −3.12E−03 | 1.37E−03 | −1.31E−03 | 3.74E−04 |
| B | 0.00E+00 | 0.00E+00 | 1.52E−04 | −7.49E−04 | −4.89E−05 | 1.22E−05 |
| C | 0.00E+00 | 0.00E+00 | −2.83E−05 | 1.29E−04 | 3.99E−06 | −1.53E−06 |
| D | 0.00E+00 | 0.00E+00 | 6.66E−06 | −1.41E−05 | 6.88E−08 | 1.71E−07 |
| E | 0.00E+00 | 0.00E+00 | −1.02E−06 | 7.51E−07 | 7.42E−10 | 1.64E−09 |
| F | 0.00E+00 | 0.00E+00 | 1.00E−07 | 3.48E−08 | −2.75E−11 | 9.50E−20 |
| G | 0.00E+00 | 0.00E+00 | −6.19E−09 | −8.49E−09 | 2.23E−21 | −8.11E−21 |
| H | 0.00E+00 | 0.00E+00 | 2.20E−10 | 5.26E−10 | −3.50E−22 | 2.04E−22 |
| J | 0.00E+00 | 0.00E+00 | −3.45E−12 | −1.17E−11 | −2.55E−24 | 1.49E−24 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −4.04E+01 | −3.01E+01 | −3.15E+00 | −4.65E+00 | 0.00E+00 | −6.33E+00 |
| A | 2.34E−02 | 3.73E−02 | 3.63E−03 | −4.89E−03 | −1.92E−02 | −1.44E−02 |
| B | −7.62E−03 | −1.31E−02 | −2.96E−03 | 2.04E−03 | 1.09E−03 | 1.71E−03 |
| C | 2.00E−03 | 3.11E−03 | 6.77E−04 | −1.00E−03 | 2.18E−04 | −1.77E−04 |
| D | −3.44E−04 | −3.57E−04 | −2.16E−05 | 3.42E−04 | −1.07E−04 | 1.47E−05 |
| E | 3.79E−05 | −3.41E−06 | −1.72E−05 | −7.05E−05 | 2.34E−05 | −8.30E−07 |
| F | −2.59E−06 | 6.57E−06 | 3.77E−06 | 8.96E−06 | −3.11E−06 | 1.49E−09 |
| G | 1.02E−07 | −8.69E−07 | −4.00E−07 | −7.07E−07 | 2.48E−07 | 4.24E−09 |
| H | −1.79E−09 | 5.20E−08 | 2.31E−08 | 3.23E−08 | −1.08E−08 | −2.97E−10 |
| J | 8.41E−14 | −1.25E−09 | −5.67E−10 | −6.50E−10 | 2.00E−10 | 6.72E−12 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Fourth Embodiment

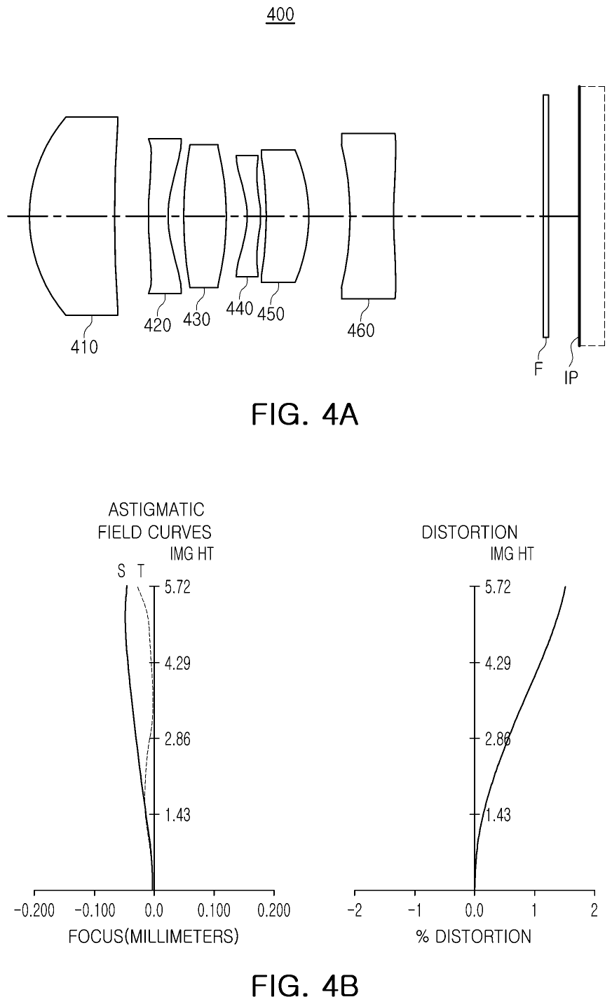

FIG. 4A is a configuration diagram illustrating an optical imaging system according to a fourth embodiment. FIG. 4B is a graph indicating aberration properties of an optical imaging system according to a fourth embodiment.

According to the fourth embodiment, the optical imaging system 400 may include a first lens 410, a second lens 420, a third lens 430, a fourth lens 440, a fifth lens 450, and a sixth lens 460 disposed in order from an object side, and may further include an infrared cut-off filter F and an image sensor IP disposed on the image side of the sixth lens 460. Also, the optical imaging system 400 may further include an aperture ST disposed on an object side of the third lens 430.

The first lens 410 may have positive refractive power. An object-side surface of the first lens 410 may be convex in a paraxial region, and an image-side surface of the first lens 410 may be concave in the paraxial region. The first lens 410 may be formed of a (low dispersion) glass material. Also, the first lens 410 may be a spherical lens. For example, an object-side surface and an image-side surface of the first lens 410 may be spherical.

The second lens 420 may have negative refractive power. An object-side surface of the second lens 420 may be convex in a paraxial region, and an image-side surface of the second lens 420 may be concave in the paraxial region. The second lens 420 may be formed of a plastic material. Accordingly, the second lens 420 may have different optical properties (e.g., a different refractive index and a different Abbe number) from those of the first lens 410. Also, the second lens 420 may be an aspherical lens. For example, an object-side surface and an image-side surface of the second lens 420 may be aspherical.

The third lens 430 may have positive refractive power. Both an object-side surface and an image-side surface of the third lens 430 may be convex in the paraxial region. The third lens 430 may be formed of a plastic material. For example, the third lens 430 may be formed of a plastic material having different optical properties (e.g., a different refractive index and a different Abbe number) from those of the second lens 420, and may be formed of a plastic material having an Abbe number higher than that of the second lens 420. Also, the third lens 430 may be an aspherical lens. For example, an object-side surface and an image-side surface of the third lens 430 may be aspherical.

The fourth lens 440 may have negative refractive power. An object-side surface of the fourth lens 440 may be concave in a paraxial region, and an image-side surface of the fourth lens 440 may be convex in the paraxial region. The fourth lens 440 may be formed of a plastic material. For example, the fourth lens 440 may be formed of a plastic material having optical properties the same as or similar to (e.g., the same or a similar refractive index and Abbe number) those of the third lens 430, and may be formed of a plastic material having an Abbe number higher than that of the fifth lens 450. Also, the fourth lens 440 may be an aspherical lens. For example, an object-side surface and an image-side surface of the fourth lens 440 may be aspherical.

The fifth lens 450 may have positive refractive power. An object-side surface of the fifth lens 450 may be concave in a paraxial region, and an image-side surface of the fifth lens 450 may be convex in the paraxial region. The fifth lens 450 may be formed of a plastic material. For example, the fifth lens 450 may be formed of a plastic material having different optical properties (e.g., a different refractive index and a different Abbe number) from those of the fourth lens 440. Also, the fifth lens 450 may be an aspherical lens. For example, an object-side surface and an image-side surface of the fifth lens 450 may be aspherical.

The sixth lens 460 may have negative refractive power. Both an object-side surface and an image-side surface of the sixth lens 460 may be concave in a paraxial region. The sixth lens 460 may be formed of a plastic material. For example, the sixth lens 460 may be formed of a plastic material having different optical properties (e.g., a different refractive index and a different Abbe number) from those of the fifth lens 450. Also, the sixth lens 460 may be an aspherical lens. For example, an object-side surface and an image-side surface of the sixth lens 460 may be aspherical.

According to the fourth embodiment, the optical imaging system 400 may include a first lens group LG1 including the first lens 410, the second lens 420 and the third lens 430, and a second lens group LG2 including the fourth lens 440, the fifth lens 450 and the sixth lens 460. The second lens group LG2 may move toward the image plane IP side when obtaining an image of a subject disposed at an ultra-short distance.

Table 7 below indicates optical and physical parameters of the optical imaging system 400 according to the fourth embodiment.

TABLE 7

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.0918 | 3.6152 | 1.4970 | 81.61 | 4.45 |
| 3 | 96.0706 | 1.3687 | | | 3.91 |
| 4 | 11.1505 | 0.8238 | 1.6144 | 25.94 | 3.42 |
| 5 | 5.1021 | 0.6169 | | | 3.21 |
| 6 | 14.7761 | 1.8000 | 1.5440 | 55.99 | 3.16 |
| 7 | −12.6742 | D1 | | | 3.00 |
| 8 | −3.0953 | 0.5426 | 1.5440 | 55.99 | 2.70 |
| 9 | −4.4309 | 0.2489 | | | 2.55 |
| 10 | −15.6480 | 1.7452 | 1.6608 | 20.38 | 2.60 |
| 11 | −8.2225 | 1.7803 | | | 2.96 |
| 12 | −19.1782 | 1.8000 | 1.6144 | 25.94 | 3.28 |
| 13 | 25.1980 | D2 | | | 3.80 |
| 14 | Infinity | 0.2100 | 1.5168 | 64.20 | 5.59 |
| 15 | Infinity | 1.3426 | | | 5.63 |
| Image | Infinity | | | | |

Table 8 below indicates aspherical data of the optical imaging system 400 according to the fourth embodiment.

TABLE 8

| Surface | 2 | 3 | 4 | 5 | 6 | 7 |
|---|---|---|---|---|---|---|
| K | 0.00E+00 | 0.00E+00 | −3.18E+01 | −9.38E+00 | 0.00E+00 | 0.00E+00 |
| A | 0.00E+00 | 0.00E+00 | −2.03E−03 | 2.78E−03 | −2.44E−04 | 1.19E−04 |
| B | 0.00E+00 | 0.00E+00 | −4.75E−04 | −1.59E−03 | −7.67E−05 | 3.98E−05 |
| C | 0.00E+00 | 0.00E+00 | 1.65E−04 | 4.58E−04 | 4.61E−07 | 2.15E−06 |
| D | 0.00E+00 | 0.00E+00 | −3.62E−05 | −1.09E−04 | 4.99E−07 | 7.49E−08 |
| E | 0.00E+00 | 0.00E+00 | 5.65E−06 | 1.89E−05 | 0.00E+00 | 0.00E+00 |
| F | 0.00E+00 | 0.00E+00 | −5.96E−07 | −2.22E−06 | 0.00E+00 | 0.00E+00 |
| G | 0.00E+00 | 0.00E+00 | 3.96E−08 | 1.64E−07 | 0.00E+00 | 0.00E+00 |
| H | 0.00E+00 | 0.00E+00 | −1.48E−09 | −6.86E−09 | 0.00E+00 | 0.00E+00 |
| J | 0.00E+00 | 0.00E+00 | 2.37E−11 | 1.23E−10 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −6.57E+00 | −2.22E+00 | −7.86E+01 | −1.48E+00 | 0.00E+00 | 9.52E+00 |
| A | 8.73E−03 | 3.52E802 | 4.19E−03 | −5.95E−04 | −7.81E−05 | −1.19E−03 |
| B | −1.07E−04 | −1.02E−02 | −4.60E−03 | 1.10E−04 | −1.46E−04 | −1.33E−05 |
| C | −6.61E−04 | 3.09E−03 | 2.12E−03 | −6.14E−05 | 9.19E−06 | −1.24E−05 |
| D | 2.89E−04 | −8.87E−04 | −7.05E−04 | 1.93E−05 | 1.5E−06 | 3.73E−06 |
| E | −6.27E−05 | 2.25E−04 | 1.74E−04 | −2.96E−06 | −2.96E−07 | −5.07E−07 |
| F | 7.36E−06 | −4.23E−05 | −2.92E−05 | 1.92E−07 | 2.23E−08 | 3.85E−08 |
| G | −4.22E−07 | 5.06E−06 | 3.08E−06 | 6.98E−10 | −5.42E−10 | −1.68E−09 |
| H | 6.14E−09 | −3.37E−07 | −1.80E−07 | −7.15E−10 | −8.47E−12 | 3.95E−11 |
| J | 2.55E−10 | 9.47E−09 | 4.45E−09 | 2.58E−11 | 3.52E−13 | −3.83E−13 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Fifth Embodiment

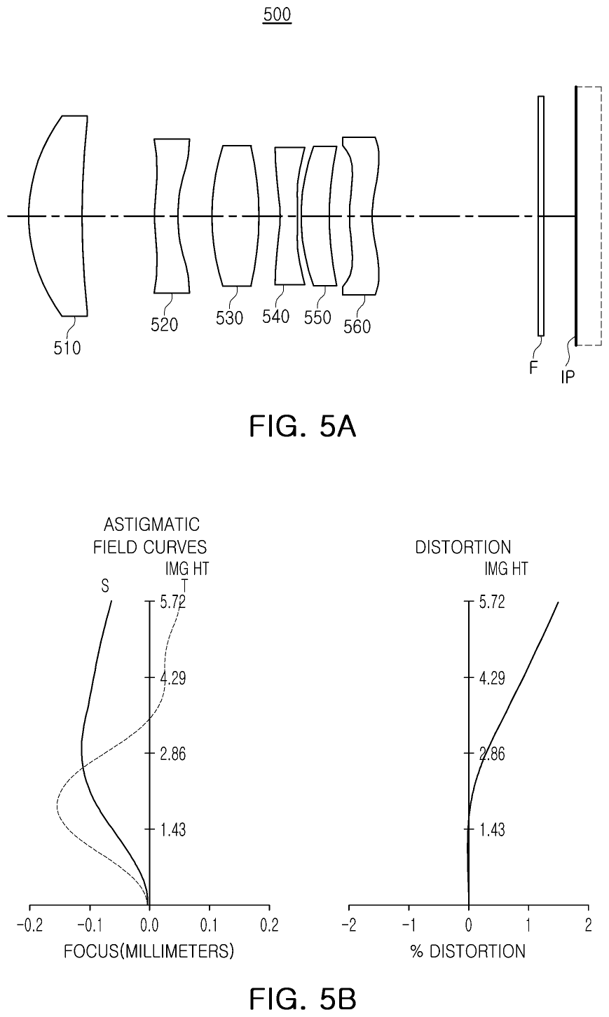

FIG. 5A is a configuration diagram illustrating an optical imaging system according to a fifth embodiment. FIG. 5B is a graph indicating aberration properties of an optical imaging system according to a fifth embodiment.

According to the fifth embodiment, the optical imaging system 500 may include a first lens 510, a second lens 520, a third lens 530, a fourth lens 540, a fifth lens 550, and a sixth lens 560 disposed in order from an object side, and may further include an infrared cut-off filter F and an image sensor IP disposed on an image side of the sixth lens 560. Also, the optical imaging system 500 may further include an aperture ST disposed on an object side of the third lens 530.

The first lens 510 may have positive refractive power. An object-side surface of the first lens 510 may be convex in a paraxial region, and an image-side surface of the first lens 510 may be concave in the paraxial region. The first lens 510 may be formed of a (low dispersion) glass material. Also, the first lens 510 may be a spherical lens. For example, an object-side surface and an image-side surface of the first lens 510 may be spherical.

The second lens 520 may have negative refractive power. An object-side surface of the second lens 520 may be convex in a paraxial region, and an image-side surface of the second lens 520 may be concave in the paraxial region. The second lens 520 may be formed of a plastic material. Accordingly, the second lens 520 may have different optical properties (e.g., a different refractive index and a different Abbe number) from those of the first lens 510. Also, the second lens 520 may be an aspherical lens. For example, an object-side surface and an image-side surface of the second lens 520 may be aspherical.

The third lens 530 may have positive refractive power. Both an object-side surface and an image-side surface of the third lens 530 may be convex in a paraxial region. The third lens 530 may be formed of a plastic material. For example, the third lens 530 may be formed of a plastic material having different optical properties (e.g., a different refractive index and a different Abbe number) from those of the second lens 520, and may be formed of a plastic material having an Abbe number higher than that of the second lens 520. Also, the third lens 530 may be an aspherical lens. For example, an object-side surface and an image-side surface of the third lens 530 may be aspherical.

The fourth lens 540 may have negative refractive power. An object-side surface of the fourth lens 540 may be concave in a paraxial region, and an image-side surface of the fourth lens 540 may be convex in the paraxial region. The fourth lens 540 may be formed of a plastic material. For example, the fourth lens 540 may be formed of a plastic material having optical properties the same as or similar to (e.g., the same or a similar refractive index and Abbe number) those of the third lens 530, and may be formed of a plastic material having an Abbe number higher than that of the fifth lens 550. Also, the fourth lens 540 may be an aspherical lens. For example, an object-side surface and an image-side surface of the fourth lens 540 may be aspherical.

The fifth lens 550 may have positive refractive power. An object-side surface of the fifth lens 550 may be convex in a paraxial region, and an image-side surface of the fifth lens 550 may be concave in the paraxial region. The fifth lens 550 may be formed of a plastic material. For example, the fifth lens 550 may be formed of a plastic material having different optical properties (e.g., a different refractive index and a different Abbe number) from those of the fourth lens 540. Also, the fifth lens 550 may be an aspherical lens. For example, an object-side surface and an image-side surface of the fifth lens 550 may be aspherical.

The sixth lens 560 may have negative refractive power. An object-side surface of the sixth lens 560 may be convex in a paraxial region, and an image-side surface of the sixth lens 560 may be concave in the paraxial region. The sixth lens 560 may be formed of a plastic material. For example, the sixth lens 560 may be formed of a plastic material having different optical properties (e.g., a different refractive index and a different Abbe number) from those of the fifth lens 550. Also, the sixth lens 560 may be an aspherical lens. For example, an object-side surface and an image-side surface of the sixth lens 560 may be aspherical.

According to the fifth embodiment, the optical imaging system 500 may include a first lens group LG1 including the first lens 510, the second lens 520 and the third lens 530, and a second lens group LG2 including the fourth lens 540, the fifth lens 550 and the sixth lens 560. The second lens group LG2 may move toward the image plane IP side when obtaining an image of a subject disposed at an ultra-short distance.

Table 9 below indicates optical and physical parameters of the optical imaging system 500 according to the fifth embodiment.

TABLE 9

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.7111 | 2.2383 | 1.4970 | 81.61 | 4.45 |
| 3 | 43.3275 | 3.0425 | | | 4.22 |
| 4 | 12.9633 | 0.9482 | 1.6144 | 25.94 | 3.41 |
| 5 | 5.2679 | 1.4210 | | | 3.26 |
| 6 | 8.8324 | 2.0000 | 1.5349 | 55.74 | 3.13 |
| 7 | −14.4264 | D1 | | | 3.13 |
| 8 | −6.5684 | 0.7382 | 1.5672 | 37.40 | 3.05 |
| 9 | −33.8623 | 0.1000 | | | 3.05 |
| 10 | 8.6983 | 1.2452 | 1.6608 | 20.38 | 3.11 |
| 11 | 15.5626 | 0.8377 | | | 3.11 |
| 12 | 7.1869 | 0.9388 | 1.5440 | 55.99 | 3.12 |
| 13 | 4.8383 | D2 | | | 3.51 |
| 14 | Infinity | 0.2100 | 1.5168 | 64.20 | 5.31 |
| 15 | Infinity | 1.3928 | | | 5.35 |
| Image | Infinity | | | | |

Table 10 below indicates aspherical data of the optical imaging system 500 according to the fifth embodiment.

TABLE 10

| Surface | 2 | 3 | 4 | 5 | 6 | 7 |
|---|---|---|---|---|---|---|
| K | 0.00E+00 | 0.00E+00 | −4.23E+01 | −1.10E+01 | 0.00E+00 | 0.00E+00 |
| A | 0.00E+00 | 0.00E+00 | −3.53E−03 | 1.59E−03 | −1.22E−03 | 7.54E−04 |
| B | 0.00E+00 | 0.00E+00 | 3.11E−05 | −1.23E−03 | −6.47E−05 | 2.29E−05 |
| C | 0.00E+00 | 0.00E+00 | 1.77E−05 | 2.89E−04 | 1.26E−06 | −2.80E−06 |
| D | 0.00E+00 | 0.00E+00 | −2.48E−06 | −4.69E−05 | −4.43E−07 | 1.03E−07 |
| E | 0.00E+00 | 0.00E+00 | 1.88E−07 | 5.13E−06 | 7.15E−08 | 2.38E−08 |
| F | 0.00E+00 | 0.00E+00 | −2.27E−09 | −3.47E−07 | −3.25E−09 | −1.26E−09 |
| G | 0.00E+00 | 0.00E+00 | −8.72E−10 | 1.24E−08 | 0.00E+00 | 0.00E+00 |
| H | 0.00E+00 | 0.00E+00 | 6.64E−11 | −1.33E−10 | 0.00E+00 | 0.00E+00 |
| J | 0.00E+00 | 0.00E+00 | −1.56E−12 | −2.50E−12 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −2.98E+00 | 9.00E+01 | −5.45E+01 | −8.28E+01 | 0.00E+00 | −1.49E+01 |
| A | 9.23E−03 | 1.72E−02 | 2.09E−02 | 6.33E−03 | −1.11E−02 | 9.36E−04 |
| B | 8.72E−04 | −1.06E−03 | −6.55E−03 | −1.01E−03 | −8.11E−04 | −2.34E−03 |
| C | −1.10E−03 | −2.28E−03 | 6.41E−04 | −3.64E−04 | 4.17E−04 | 5.15E−04 |
| D | 3.92E−04 | 1.20E−03 | 1.81E−04 | 1.92E−04 | −1.38E−04 | −5.88E−05 |
| E | −7.81E−05 | −2.90E−04 | −6.40E−05 | −3.44E−05 | 3.70E−05 | 2.99E−06 |
| F | 9.32E−06 | 3.97E−05 | 8.41E−06 | 2.68E−06 | −6.41E−06 | 5.78E−08 |
| G | −6.56E−07 | −3.17E−06 | −5.57E−07 | −4.39E−08 | 6.41E−07 | −1.59E−08 |
| H | 2.50E−08 | 1.38E−07 | 1.77E−08 | −5.59E−09 | −3.39E−08 | 7.77E−10 |
| J | −3.90E−10 | −2.56E−09 | −1.90E−10 | 2.42E−10 | 7.38E−10 | −1.32E−11 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Sixth Embodiment

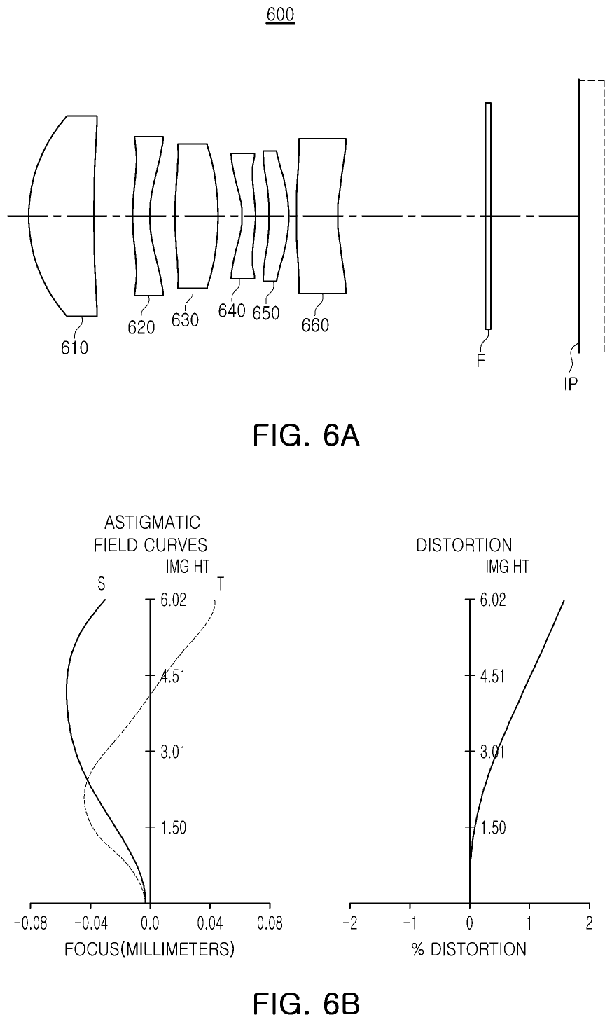

FIG. 6A is a configuration diagram illustrating an optical imaging system according to a sixth embodiment. FIG. 6B is a graph indicating aberration properties of an optical imaging system according to a sixth embodiment.

According to a sixth embodiment, an optical imaging system 600 may include a first lens 610, a second lens 620, a third lens 630, a fourth lens 640, a fifth lens 650, and a sixth lens 660 disposed in order from an object side, and may further include an infrared cut-off filter F and an image sensor IP disposed on the image side of the sixth lens 660. Also, the optical imaging system 600 may further include an aperture ST disposed on an object side of the third lens 630.

The first lens 610 may have positive refractive power. An object-side surface of the first lens 610 may be convex in a paraxial region, and an image-side surface of the first lens 610 may be concave in the paraxial region. The first lens 610 may be formed of a (low dispersion) glass material. Also, the first lens 610 may be a spherical lens. For example, an object-side surface and an image-side surface of the first lens 610 may be spherical.

The second lens 620 may have negative refractive power. An object-side surface of the second lens 620 may be convex in a paraxial region, and an image-side surface of the second lens 620 may be concave in the paraxial region. The second lens 620 may be formed of a plastic material. Accordingly, the second lens 620 may have different optical properties (e.g., a different refractive index and a different Abbe number) from those of the first lens 610. Also, the second lens 620 may be an aspherical lens. For example, an object-side surface and an image-side surface of the second lens 620 may be aspherical.

The third lens 630 may have positive refractive power. Both an object-side surface and an image-side surface of the third lens 630 may be convex in a paraxial region. The third lens 630 may be formed of a plastic material. For example, the third lens 630 may be formed of a plastic material having different optical properties (e.g., a different refractive index and a different Abbe number) from those of the second lens 620, and may be formed of a plastic material having an Abbe number higher than that of the second lens 620. Also, the third lens 630 may be an aspherical lens. For example, an object-side surface and an image-side surface of the third lens 630 may be aspherical.

The fourth lens 640 may have negative refractive power. An object-side surface of the fourth lens 640 may be concave in a paraxial region, and an image-side surface of the fourth lens 640 may be convex in the paraxial region. The fourth lens 640 may be formed of a plastic material. For example, the fourth lens 640 may be formed of a plastic material having optical properties the same as or similar to (e.g., the same or a similar refractive index and Abbe number) those of the third lens 630, and may be formed of a plastic material having an Abbe number higher than that of the fifth lens 650. Also, the fourth lens 640 may be an aspherical lens. For example, an object-side surface and an image-side surface of the fourth lens 640 may be aspherical.

The fifth lens 650 may have positive refractive power. An object-side surface of the fifth lens 650 may be concave in a paraxial region, and an image-side surface of the fifth lens 650 may be convex in the paraxial region. The fifth lens 650 may be formed of a plastic material. For example, the fifth lens 650 may be formed of a plastic material having different optical properties (e.g., a different refractive index and a different Abbe number) from those of the fourth lens 640. Also, the fifth lens 650 may be an aspherical lens. For example, an object-side surface and an image-side surface of the fifth lens 650 may be aspherical.

The sixth lens 660 may have negative refractive power. An object-side surface of the sixth lens 660 may be convex in a paraxial region, and an image-side surface of the sixth lens 660 may be concave in the paraxial region. The sixth lens 660 may be formed of a plastic material. For example, the sixth lens 660 may be formed of a plastic material having different optical properties (e.g., a different refractive index and a different Abbe number) from those of the fifth lens 650. Also, the sixth lens 660 may be an aspherical lens. For example, an object-side surface and an image-side surface of the sixth lens 660 may be aspherical.

According to the sixth embodiment, the optical imaging system 600 may include a first lens group LG1 including the first lens 610, the second lens 620 and the third lens 630, and a second lens LG2 group including the fourth lens 640, the fifth lens 650 and the sixth lens 660. The second lens group LG2 may move toward the image plane IP side when obtaining an image of a subject disposed at an ultra-short distance.

Table 11 below indicates optical and physical parameters of the optical imaging system 600 according to the sixth embodiment.

TABLE 11

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 6.9226 | 2.7123 | 1.4970 | 81.61 | 4.45 |
| 3 | 66.7880 | 1.6429 | | | 4.13 |
| 4 | 10.3802 | 0.6972 | 1.6144 | 25.94 | 3.55 |
| 5 | 5.2090 | 1.0839 | | | 3.35 |
| 6 | 23.4881 | 1.8000 | 1.5440 | 55.99 | 3.23 |
| 7 | −11.9605 | D1 | | | 3.14 |
| 8 | −3.0022 | 0.5654 | 1.5440 | 55.99 | 2.80 |
| 9 | −4.2647 | 0.5486 | | | 2.66 |
| 10 | −9.1709 | 0.8358 | 1.6708 | 19.24 | 2.79 |
| 11 | −5.4460 | 0.3096 | | | 2.91 |
| 12 | 24.1549 | 1.7406 | 1.6708 | 19.24 | 3.13 |
| 13 | 7.4336 | D2 | | | 3.43 |
| 14 | Infinity | 0.2100 | 1.5168 | 64.20 | 5.01 |
| 15 | Infinity | 3.6437 | | | 5.04 |
| Image | Infinity | | | | |

Table 12 below indicates aspherical data of the optical imaging system 600 according to the sixth embodiment.

TABLE 12

| Surface | 2 | 3 | 4 | 5 | 6 | 7 |
|---|---|---|---|---|---|---|
| K | 0.00E+00 | 0.00E+00 | −2.46E+01 | −8.72E+00 | 0.00E+00 | 0.00E+00 |
| A | 0.00E+00 | 0.00E+00 | −2.24E−03 | 2.01E−03 | −2.39E−04 | −1.34E−04 |
| B | 0.00E+00 | 0.00E+00 | −1.79E−04 | −9.11E−04 | −9.25E−05 | −2.81E−06 |
| C | 0.00E+00 | 0.00E+00 | 2.78E−05 | 1.42E−04 | −1.82E−06 | 1.57E−08 |
| D | 0.00E+00 | 0.00E+00 | 1.58E−06 | −1.15E−05 | 2.13E−07 | 5.25E−08 |
| E | 0.00E+00 | 0.00E+00 | −9.16E−07 | −4.10E−07 | 0.00E+00 | 0.00E+00 |
| F | 0.00E+00 | 0.00E+00 | 1.33E−07 | 2.25E−07 | 0.00E+00 | 0.00E+00 |
| G | 0.00E+00 | 0.00E+00 | −1.03E−08 | −2.56E−08 | 0.00E+00 | 0.00E+00 |
| H | 0.00E+00 | 0.00E+00 | 4.24E−10 | 1.35E−09 | 0.00E+00 | 0.00E+00 |
| J | 0.00E+00 | 0.00E+00 | −7.36E−12 | −2.86E−11 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −7.31E+00 | −3.87E+00 | −7.91E+01 | −5.33E+00 | 0.00E+00 | −1.28E+01 |
| A | 9.32E−03 | 3.67E−02 | −4.07E−03 | −9.26E−04 | −2.00E−03 | −2.12E−03 |
| B | 7.72E−05 | −9.68E−03 | 4.71E−04 | 4.08E−04 | 1.04E−03 | 2.84E−04 |
| C | −8.17E−04 | 2.33E−03 | 8.67E−05 | 7.07E−05 | −3.24E−04 | −8.20E−05 |
| D | 3.39E−04 | −4.54E−04 | 3.73E−05 | −2.10E−05 | 4.83E−05 | 1.57E−05 |
| E | −7.93E−05 | 6.76E−05 | −3.27E−05 | −4.02E−06 | −2.57E−06 | −1.90E−06 |
| F | 1.17E−05 | −7.15E−06 | 9.12E−06 | 2.60E−06 | −2.42E−07 | 1.45E−07 |
| G | −1.08E−06 | 4.77E−07 | −1.29E−06 | −4.60E−07 | 4.52E−08 | −6.64E−09 |
| H | 5.77E−08 | −1.69E−08 | 9.30E−08 | 3.57E−08 | −2.58E−09 | 1.65E−10 |
| J | −1.37E−09 | 2.27E−10 | −2.69E−09 | −1.05E−09 | 5.23E−11 | −1.64E−12 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Seventh Embodiment

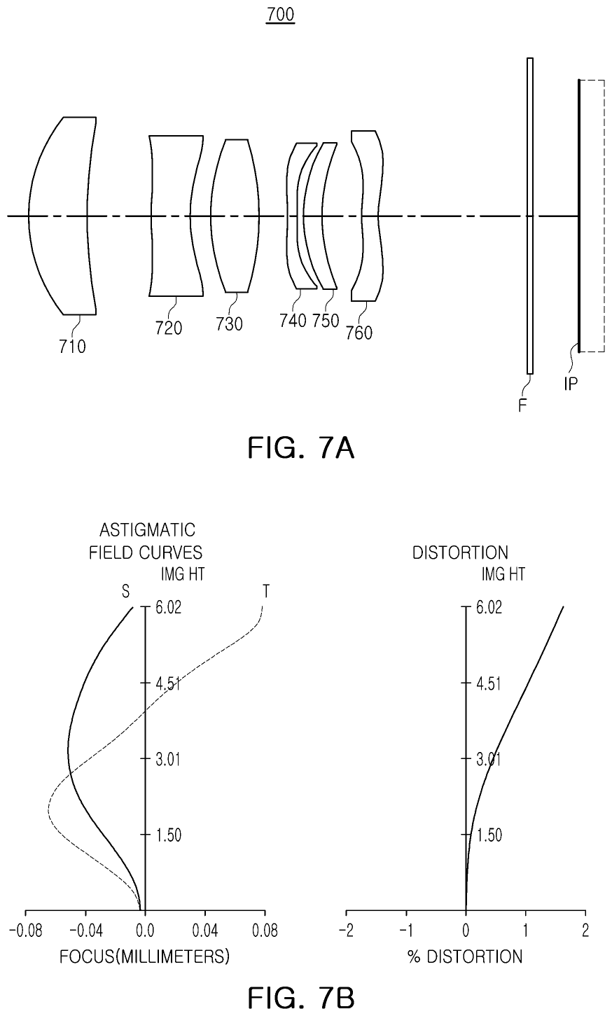

FIG. 7A is a configuration diagram illustrating an optical imaging system according to a seventh embodiment. FIG. 7B is a graph indicating aberration properties of an optical imaging system according to a seventh embodiment.

According to a seventh embodiment, an optical imaging system 700 may include a first lens 710, a second lens 720, a third lens 730, a fourth lens 740, a fifth lens 750, and a sixth lens 760 disposed in order from an object side, and may further include an infrared cut-off filter F and an image sensor IP disposed on the image side of the sixth lens 760. Also, the optical imaging system 700 may further include an aperture ST disposed on an object side of the third lens 730.

The first lens 710 may have positive refractive power. An object-side surface of the first lens 710 may be convex in a paraxial region, and an image-side surface of the first lens 710 may be concave in the paraxial region. The first lens 710 may be formed of a (low dispersion) glass material. Also, the first lens 710 may be a spherical lens. For example, an object-side surface and an image-side surface of the first lens 710 may be spherical.

The second lens 720 may have negative refractive power. An object-side surface of the second lens 720 may be convex in a paraxial region, and an image-side surface of the second lens 720 may be concave in the paraxial region. The second lens 720 may be formed of a plastic material. Accordingly, the second lens 720 may have different optical properties (e.g., a different refractive index and a different Abbe number) from those of the first lens 710. Also, the second lens 720 may be an aspherical lens. For example, an object-side surface and an image-side surface of the second lens 720 may be aspherical.

The third lens 730 may have positive refractive power. Both an object-side surface and an image-side surface of the third lens 730 may be convex in a paraxial region. The third lens 730 may be formed of a plastic material. For example, the third lens 730 may be formed of a plastic material having different optical properties (e.g., a different refractive index and a different Abbe number) from those of the second lens 720, and may be formed of a plastic material having an Abbe number higher than that of the second lens 720. Also, the third lens 730 may be an aspherical lens. For example, an object-side surface and an image-side surface of the third lens 730 may be aspherical.

The fourth lens 740 may have negative refractive power. An object-side surface of the fourth lens 740 may be concave in a paraxial region, and an image-side surface of the fourth lens 740 may be convex in the paraxial region. The fourth lens 740 may be formed of a plastic material. For example, the fourth lens 740 may be formed of a plastic material having optical properties the same as or similar to (e.g., the same or a similar refractive index and Abbe number) those of the third lens 730, and may be formed of a plastic material having an Abbe number higher than that of the fifth lens 750. Also, the fourth lens 740 may be an aspherical lens. For example, an object-side surface and an image-side surface of a fourth lens 740 may be aspherical.

The fifth lens 750 may have positive refractive power. An object-side surface of the fifth lens 750 may be convex in a paraxial region, and an image-side surface of the fifth lens 750 may be concave in the paraxial region. The fifth lens 750 may be formed of a plastic material. For example, the fifth lens 750 may be formed of a plastic material having different optical properties (e.g., a different refractive index and a different Abbe number) from those of the fourth lens 740. Also, the fifth lens 750 may be an aspherical lens. For example, an object-side surface and an image-side surface of the fifth lens 750 may be aspherical.

The sixth lens 760 may have negative refractive power. An object-side surface of the sixth lens 760 may be convex in the paraxial region, and an image-side surface of the sixth lens 760 may be concave in the paraxial region. The sixth lens 760 may be formed of a plastic material. For example, the sixth lens 760 may be formed of a plastic material having different optical properties (e.g., a different refractive index and a different Abbe number) from those of the fifth lens 750. Also, the sixth lens 760 may be an aspherical lens. For example, an object-side surface and an image-side surface of the sixth lens 760 may be aspherical.

According to the seventh embodiment, the optical imaging system 700 may include a first lens group LG1 including the first lens 710, the second lens 720 and the third lens 730, and a second lens group LG2 including the fourth lens 740, the fifth lens 750 and the sixth lens 760. The second lens group LG2 may move toward the image plane IP side when obtaining an image of a subject disposed at an ultra-short distance.

Table 13 below indicates optical and physical parameters of the optical imaging system 700 according to the seventh embodiment.

TABLE 13

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.3632 | 2.4332 | 1.4565 | 90.27 | 4.40 |
| 3 | 23.0192 | 2.6790 | | | 4.10 |
| 4 | 23.1532 | 1.6381 | 1.6144 | 25.94 | 3.57 |
| 5 | 5.9459 | 0.8497 | | | 3.40 |
| 6 | 7.7018 | 2.000 | 1.5349 | 55.74 | 3.39 |
| 7 | −11.1273 | D1 | | | 3.27 |
| 8 | −8.7971 | 0.400 | 1.5440 | 55.99 | 3.25 |
| 9 | −58.4959 | 0.2508 | | | 3.10 |
| 10 | 5.0071 | 0.7801 | 1.6608 | 20.38 | 3.25 |
| 11 | 5.5434 | 1.6873 | | | 3.14 |
| 12 | 8.0544 | 0.6818 | 1.5349 | 55.74 | 3.30 |
| 13 | 5.0787 | D2 | | | 3.80 |
| 14 | Infinity | 0.2100 | 1.5168 | 64.20 | 7.00 |
| 15 | Infinity | 1.9794 | | | 7.00 |
| Image | Infinity | | | | |

Table 14 below indicates aspherical data of the optical imaging system 700 according to the seventh embodiment.

TABLE 14

| Surface | 2 | 3 | 4 | 5 | 6 | 7 |
|---|---|---|---|---|---|---|
| K | 0.00E+00 | 0.00E+00 | −2.23E+01 | −1.09E+01 | 0.00E+00 | 0.00E+00 |
| A | 0.00E+00 | 0.00E+00 | −3.06E−03 | 1.27E−03 | −1.37E−03 | 3.64E−04 |
| B | 0.00E+00 | 0.00E+00 | 1.62E−04 | −6.76E−04 | −4.84E−05 | 1.11E−05 |
| C | 0.00E+00 | 0.00E+00 | −3.34E−05 | 1.04E−04 | 4.04E−06 | −1.46E−06 |
| D | 0.00E+00 | 0.00E+00 | 7.81E−06 | −8.36E−06 | 7.15E−08 | 1.80E−07 |
| E | 0.00E+00 | 0.00E+00 | −1.18E−06 | −1.76E−07 | 2.65E−09 | 1.57E−09 |
| F | 0.00E+00 | 0.00E+00 | 1.13E−07 | 1.33E−07 | −1.23E−10 | 1.28E−19 |
| G | 0.00E+00 | 0.00E+00 | −6.73E−09 | −1.51E−08 | 2.23E−21 | −7.71E−21 |
| H | 0.00E+00 | 0.00E+00 | 2.30E−10 | 7.75E−10 | −5.22E−22 | 2.98E−22 |
| J | 0.00E+00 | 0.00E+00 | −3.47E−12 | −1.58E−11 | −3.80E−24 | 2.20E−24 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −4.25E+01 | −9.00E+01 | −3.00E+00 | −4.54E+00 | 0.00E+00 | −6.20E+00 |
| A | 2.41E−02 | 3.78E−02 | 3.89E−03 | −4.59E−03 | −1.92E−02 | −1.43E−02 |
| B | −8.45E−03 | −1.43E−02 | −3.33E−03 | 1.90E−03 | 1.10E−03 | 1.65E−03 |
| C | 2.44E−03 | 3.88E−03 | 9.02E−04 | −9.87E−04 | 1.91E−04 | −1.58E−04 |
| D | −4.81E−04 | −6.25E−04 | −8.60E−05 | 3.65E−04 | −8.64E−05 | 1.21E−05 |
| E | 6.45E−05 | 5.25E−05 | −8.04E−06 | −8.31E−05 | 1.67E−05 | −8.30E−07 |
| F | −5.84E−06 | −6.34E−07 | 3.27E−06 | 1.19E−05 | −1.89E−06 | 5.09E−08 |
| G | 3.46E−07 | −3.03E−07 | −4.20E−07 | −1.06E−06 | 1.22E−07 | −2.32E−09 |
| H | −1.21E−08 | 2.70E−08 | 2.66E−08 | 5.47E−08 | −3.88E−09 | 6.79E−11 |
| J | 1.87E−10 | −7.67E−10 | −6.84E−10 | −1.23E−09 | 3.98E−11 | −9.74E−13 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Eighth Embodiment

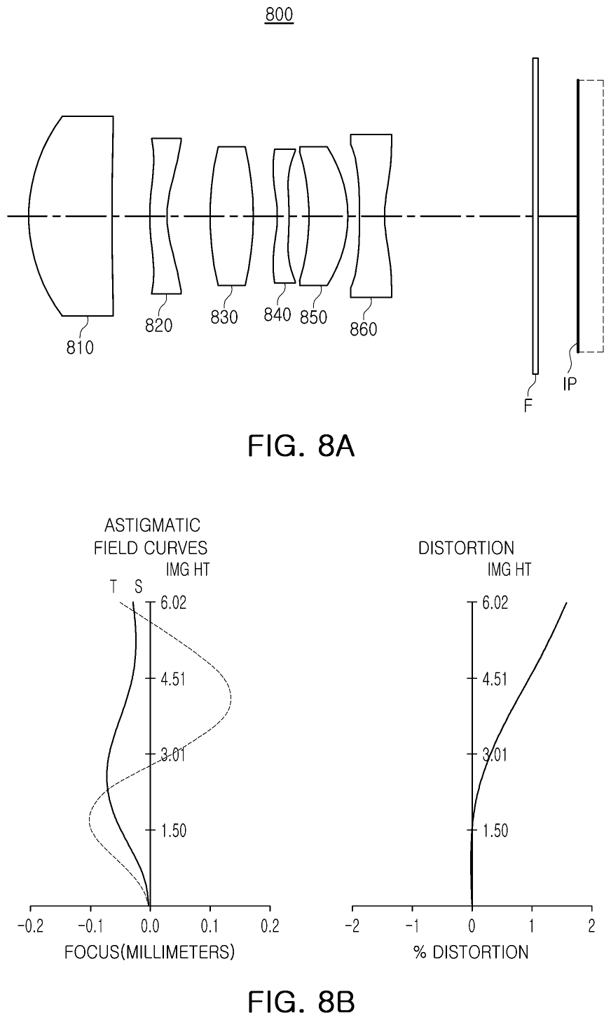

FIG. 8A is a configuration diagram illustrating an optical imaging system according to an eighth embodiment. FIG. 8B is a graph indicating aberration properties of an optical imaging system according to an eighth embodiment.

According to an eighth embodiment, an optical imaging system 800 may include a first lens 810, a second lens 820, a third lens 830, a fourth lens 840, a fifth lens 850, and a sixth lens 860 disposed in order from an object side, and may further include an infrared cut-off filter F and an image sensor IP disposed on an image side of the sixth lens 860. Also, the optical imaging system 800 may further include an aperture ST disposed on an object side of the third lens 830.

The first lens 810 may have positive refractive power. An object-side surface of the first lens 810 may be convex in a paraxial region, and an image-side surface of the first lens 810 may be concave in the paraxial region. The first lens 810 may be formed of a (low dispersion) glass material. Also, the first lens 810 may be a spherical lens. For example, an object-side surface and an image-side surface of the first lens 810 may be spherical.

The second lens 820 may have negative refractive power. An object-side surface of the second lens 820 may be convex in a paraxial region, and an image-side surface of the second lens 820 may be concave in the paraxial region. The second lens 820 may be formed of a plastic material. Accordingly, the second lens 820 may have different optical properties (e.g., a different refractive index and a different Abbe number) from those of the first lens 810. Also, the second lens 820 may be an aspherical lens. For example, an object-side surface and an image-side surface of the second lens 820 may be aspherical.

The third lens 830 may have positive refractive power. Both an object-side surface and an image-side surface of the third lens 830 may be convex in a paraxial region. The third lens 830 may be formed of a plastic material. For example, the third lens 830 may be formed of a plastic material having different optical properties (e.g., a different refractive index and a different Abbe number) from those of the second lens 820, and may be formed of a plastic material having an Abbe number higher than that of the second lens 820. Also, the third lens 830 may be an aspherical lens. For example, an object-side surface and an image-side surface of the third lens 830 may be aspherical.

The fourth lens 840 may have negative refractive power. An object-side surface of the fourth lens 840 may be concave in a paraxial region, and an image-side surface of the fourth lens 840 may be convex in the paraxial region. The fourth lens 840 may be formed of a plastic material. For example, the fourth lens 840 may be formed of a plastic material having optical properties the same as or similar to (e.g., the same or a similar refractive index and Abbe number) those of the third lens 830, and may be formed of a plastic material having an Abbe number higher than that of the fifth lens 850. Also, the fourth lens 840 may be an aspherical lens. For example, an object-side surface and an image-side surface of the fourth lens 840 may be aspherical.

The fifth lens 850 may have positive refractive power. An object-side surface of the fifth lens 850 may be concave in a paraxial region, and an image-side surface of the fifth lens 850 may be convex in the paraxial region. The fifth lens 850 may be formed of a plastic material. For example, the fifth lens 850 may be formed of a plastic material having different optical properties (e.g., a different refractive index and a different Abbe number) from those of the fourth lens 840. Also, the fifth lens 850 may be an aspherical lens. For example, an object-side surface and an image-side surface of the fifth lens 850 may be aspherical.

The sixth lens 860 may have negative refractive power. Both an object-side surface and an image-side surface of the sixth lens 860 may be concave in a paraxial region. The sixth lens 860 may be formed of a plastic material. For example, the sixth lens 860 may be formed of a plastic material having different optical properties (e.g., a different refractive index and a different Abbe number) from those of the fifth lens 850. Also, the sixth lens 860 may be an aspherical lens.

For example, an object-side surface and an image-side surface of the sixth lens 860 may be aspherical.

According to the eighth embodiment, the optical imaging system 800 may include a first lens group LG1 including the first lens 810, the second lens 820 and the third lens 830, and a second lens group LG2 including the fourth lens 840, the fifth lens 850 and the sixth lens 860. The second lens group LG2 may move toward the image plane IP side when obtaining an image of a subject disposed at an ultra-short distance.

Table 15 below indicates optical and physical parameters of the optical imaging system 800 according to the eighth embodiment.

TABLE 15

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.7589 | 3.5000 | 1.4970 | 81.61 | 4.45 |
| 3 | 153.7500 | 1.5758 | | | 3.97 |
| 4 | 8.8885 | 0.7245 | 1.6144 | 25.94 | 3.45 |
| 5 | 4.8285 | 1.8002 | | | 3.28 |
| 6 | 13.2455 | 1.8000 | 1.5349 | 55.74 | 3.08 |
| 7 | −14.4217 | D1 | | | 3.10 |
| 8 | −4.8673 | 0.5196 | 1.5440 | 55.99 | 2.98 |
| 9 | −6.4521 | 0.7965 | | | 2.89 |
| 10 | −9.7260 | 1.6138 | 1.6608 | 20.38 | 2.90 |
| 11 | −4.9168 | 0.5120 | | | 3.10 |
| 12 | −25.9701 | 1.0581 | 1.6144 | 25.94 | 3.23 |
| 13 | 6.8141 | D2 | | | 3.59 |
| 14 | Infinity | 0.2100 | 1.5168 | 64.20 | 7.00 |
| 15 | Infinity | 1.6790 | | | 7.00 |
| Image | Infinity | | | | |

Table 16 below indicates aspherical data of the optical imaging system 800 according to the eighth embodiment.

TABLE 16

| Surface | 2 | 3 | 4 | 5 | 6 | 7 |
|---|---|---|---|---|---|---|
| K | 0.00E+00 | 0.00E+00 | −2.85E+01 | −9.76E+00 | 0.00E+00 | 0.00E+00 |
| A | 0.00E+00 | 0.00E+00 | −1.93E−03 | 2.69E−03 | −7.20E−05 | 2.51E−04 |
| B | 0.00E+00 | 0.00E+00 | −8.23E−05 | −1.26E−03 | −7.34E−05 | 1.86E−06 |
| C | 0.00E+00 | 0.00E+00 | −9.22E−05 | 1.90E−04 | 2.62E−07 | −2.28E−06 |
| D | 0.00E+00 | 0.00E+00 | 3.92E−05 | −1.25E−05 | 2.40E−07 | 2.19E−07 |
| E | 0.00E+00 | 0.00E+00 | −7.39E−06 | −7.98E−07 | 0.00E+00 | 0.00E+00 |
| F | 0.00E+00 | 0.00E+00 | −8.10E−07 | 2.59E−07 | 0.00E+00 | 0.00E+00 |
| G | 0.00E+00 | 0.00E+00 | −5.29E−08 | −2.45E−08 | 0.00E+00 | 0.00E+00 |
| H | 0.00E+00 | 0.00E+00 | 1.91E−09 | 1.10E−09 | 0.00E+00 | 0.00E+00 |
| J | 0.00E+00 | 0.00E+00 | −2.95E−11 | −1.99E−11 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −1.26E+01 | −3.82E+00 | −7.37E+01 | −3.71E+00 | 2.00E+00 | −1.94E+00 |
| A | 1.18E−02 | 2.55E−02 | −2.66E−03 | 3.35E−03 | 1.50E−05 | −7.67E−03 |
| B | 3.72E−05 | −1.04E−03 | 1.47E−03 | −1.27E−04 | −5.28E−04 | 8.08E−04 |
| C | −7.11E−04 | −1.26E−03 | −4.25E−04 | −3.12E−04 | 6.21E−05 | −1.08E−04 |
| D | 2.70E−04 | 6.18E−04 | 5.18E−05 | 1.24E−04 | −4.43E−07 | 1.37E−05 |
| E | −6.36E−05 | −1.70E−04 | 1.54E−07 | −2.73E−05 | −1.44E−06 | −1.36E−06 |
| F | 9.98E−06 | 2.91E−05 | −1.19E−06 | 3.69E−06 | 3.25E−07 | 9.79E−08 |
| G | −9.88E−07 | −3.02E−06 | 2.03E−07 | −2.99E−07 | −3.44E−08 | −4.84E−09 |
| H | 5.51E−08 | 1.74E−07 | −1.57E−08 | 1.33E−08 | 1.79E−09 | 1.45E−10 |
| J | −1.31E−09 | −4.23E−09 | 4.81E−10 | −2.49E−10 | −3.71E−11 | −1.96E−12 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Ninth Embodiment

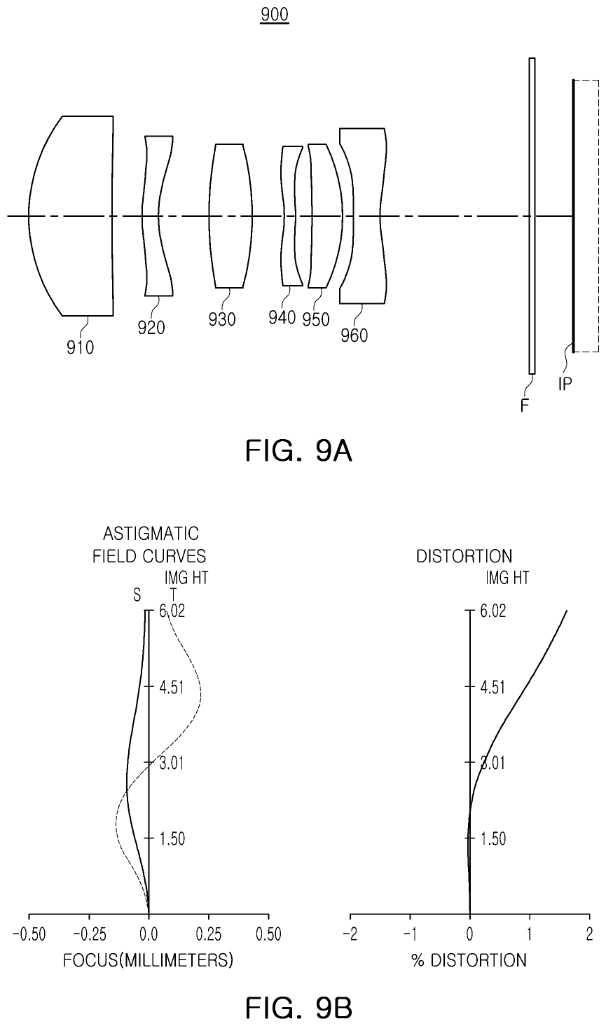

FIG. 9A is a configuration diagram illustrating an optical imaging system according to a ninth embodiment. FIG. 9B is a graph indicating aberration properties of an optical imaging system according to a ninth embodiment.

According to a ninth embodiment, an optical imaging system 900 may include a first lens 910, a second lens 920, a third lens 930, a fourth lens 940, a fifth lens 950, and a sixth lens 960 disposed in order from an object side, and may further include an infrared cut-off filter F and an image sensor IP disposed on an image side of the sixth lens 960. Also, the optical imaging system 900 may further include an aperture ST disposed on an object side of the third lens 930.

The first lens 910 may have positive refractive power. An object-side surface of the first lens 910 may be convex in a paraxial region, and an image-side surface of the first lens 910 may be concave in the paraxial region. The first lens 910 may be formed of a (low dispersion) glass material. Also, the first lens 910 may be a spherical lens. For example, an object-side surface and an image-side surface of the first lens 910 may be spherical.

The second lens 920 may have negative refractive power. An object-side surface of the second lens 920 may be convex in the paraxial region, and an image-side surface of the second lens 920 may be concave in the paraxial region. The second lens 920 may be formed of a plastic material. Accordingly, the second lens 920 may have different optical properties (e.g., a different refractive index and a different Abbe number) from those of the first lens 910. Also, the second lens 920 may be an aspherical lens. For example, an object-side surface and an image-side surface of the second lens 920 may be aspherical.

The third lens 930 may have positive refractive power. Both an object-side surface and an image-side surface of the third lens 930 may be convex in a paraxial region. The third lens 930 may be formed of a plastic material. For example, the third lens 930 may be formed of a plastic material having different optical properties (e.g., a different refractive index and a different Abbe number) from those of the second lens 920, and may be formed of a plastic material having an Abbe number higher than that of the second lens 920. Also, the third lens 930 may be an aspherical lens. For example, an object-side surface and an image-side surface of the third lens 930 may be aspherical.

The fourth lens 940 may have negative refractive power. An object-side surface of the fourth lens 940 may be concave in a paraxial region, and an image-side surface of the fourth lens 940 may be convex in the paraxial region. The fourth lens 940 may be formed of a plastic material. For example, the fourth lens 940 may be formed of a plastic material having optical properties the same as or similar to (e.g., the same or a similar refractive index and Abbe number) those of the third lens 930, and may be formed of a plastic material having an Abbe number higher than that of the fifth lens 950. Also, the fourth lens 940 may be an aspherical lens. For example, an object-side surface and an image-side surface of the fourth lens 940 may be aspherical.

The fifth lens 950 may have positive refractive power. An object-side surface of the fifth lens 950 may be concave in a paraxial region, and an image-side surface of the fifth lens 950 may be convex in the paraxial region. The fifth lens 950 may be formed of a plastic material. For example, the fifth lens 950 may be formed of a plastic material having different optical properties (e.g., a different refractive index and a different Abbe number) from those of the fourth lens 940. Also, the fifth lens 950 may be an aspherical lens. For example, an object-side surface and an image-side surface of the fifth lens 950 may be aspherical.

The sixth lens 960 may have negative refractive power. Both an object-side surface and an image-side surface of the sixth lens 960 may be concave in a paraxial region. The sixth lens 960 may be formed of a plastic material. For example, the sixth lens 960 may be formed of a plastic material having different optical properties (e.g., a different refractive index and a different Abbe number) from those of the fifth lens 950. Also, the sixth lens 960 may be an aspherical lens. For example, an object-side surface and an image-side surface of the sixth lens 960 may be aspherical.

According to the ninth embodiment, the optical imaging system 900 may include a first lens group LG1 including the first lens 910, the second lens 920 and the third lens 930, and a second lens group LG2 including the fourth lens 940, the fifth lens 950 and the sixth lens 960. The second lens group LG2 may move toward the image plane IP side when obtaining an image of a subject disposed at an ultra-short distance.

Table 17 below indicates optical and physical parameters of the optical imaging system 900 according to the ninth embodiment.

TABLE 17

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.8582 | 3.5000 | 1.4970 | 81.61 | 4.45 |
| 3 | 109.6102 | 1.2658 | | | 3.97 |
| 4 | 7.7262 | 0.6771 | 1.690 | 25.80 | 3.56 |
| 5 | 4.5006 | 2.1115 | | | 3.41 |
| 6 | 13.5102 | 1.8000 | 1.5349 | 55.74 | 3.18 |
| 7 | −14.5430 | D1 | | | 3.15 |
| 8 | −5.3925 | 0.4688 | 1.5440 | 55.99 | 3.09 |
| 9 | −7.2108 | 0.6800 | | | 3.04 |
| 10 | −18.3463 | 1.2536 | 1.6190 | 25.80 | 3.08 |
| 11 | −7.1833 | 0.4930 | | | 3.20 |
| 12 | −44.0135 | 1.1046 | 1.5672 | 37.40 | 3.22 |
| 13 | 6.6323 | D2 | | | 3.90 |
| 14 | Infinity | 0.2100 | 1.5168 | 64.20 | 7.00 |
| 15 | Infinity | 1.6721 | | | 7.00 |
| Image | Infinity | | | | |

Table 18 below indicates aspherical data of the optical imaging system 900 according to the ninth embodiment.

TABLE 18

| Surface | 2 | 3 | 4 | 5 | 6 | 7 |
|---|---|---|---|---|---|---|
| K | 0.00E+00 | 0.00E+00 | −2.57E+01 | −9.66E+00 | 0.00E+00 | 0.00E+00 |
| A | 0.00E+00 | 0.00E+00 | −5.39E−04 | 4.21E−03 | −1.61E−04 | 1.91E−04 |
| B | 0.00E+00 | 0.00E+00 | −7.30E−04 | −2.04E−03 | −7.21E−05 | −5.69E−06 |
| C | 0.00E+00 | 0.00E+00 | 9.38E−05 | 4.14E−04 | −3.03E−07 | −2.19E−06 |
| D | 0.00E+00 | 0.00E+00 | 1.59E−06 | −5.65E−05 | 1.67E−07 | 1.50E−07 |
| E | 0.00E+00 | 0.00E+00 | −2.08E−06 | 5.16E−06 | 0.00E+00 | 0.00E+00 |
| F | 0.00E+00 | 0.00E+00 | 3.05E−07 | −2.89E−07 | 0.00E+00 | 0.00E+00 |
| G | 0.00E+00 | 0.00E+00 | −2.22E−08 | 8.13E−09 | 0.00E+00 | 0.00E+00 |
| H | 0.00E+00 | 0.00E+00 | 8.38E−10 | −2.58E−11 | 0.00E+00 | 0.00E+00 |
| J | 0.00E+00 | 0.00E+00 | −1.31E−11 | −2.75E−12 | 0.00E+00 | 0.00E+00 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −1.32E+01 | −2.46E+00 | −2.00E+00 | −4.09E+00 | 2.00E+00 | −2.00E+00 |
| A | 1.25E−02 | 2.45E−02 | 8.53E−03 | 2.58E−03 | −6.20E−03 | −9.58E−03 |
| B | 2.21E−03 | 3.72E−03 | 5.56E−05 | 1.78E−03 | 1.45E−03 | 1.36E−03 |
| C | −2.76E−03 | −5.03E−03 | −8.23E−04 | −1.31E−03 | −7.31E−04 | −2.66E−04 |
| D | 1.05E−03 | 1.95E−03 | 2.36E−04 | 3.76E−04 | 2.10E−04 | 4.83E−05 |
| E | −2.25E−04 | −4.29E−04 | −2.61E−05 | −6.09E−05 | −3.53E−05 | −6.36E−06 |
| F | 2.96E−05 | 5.79E−05 | −3.02E−07 | 5.72E−06 | 3.51E−06 | 5.54E−07 |
| G | −2.37E−06 | −4.75E−06 | 3.47E−07 | −2.92E−07 | −1.96E−07 | −3.00E−08 |
| H | 1.06E−07 | 2.18E−07 | −3.04E−08 | 6.50E−09 | 5.32E−09 | 9.09E−10 |
| J | −2.03E−09 | −4.30E−09 | 8.66E−10 | −1.70E−11 | −4.54E−11 | −1.18E−11 |
| L | 0.00E+00 | 0.00E+00 | 0.00E+00 | 0.00E+00 | 0.00E+00 | 0.00E+00 |
| M | 0.00E+00 | 0.00E+00 | 0.00E+00 | 0.00E+00 | 0.00E+00 | 0.00E+00 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

### Tenth Embodiment

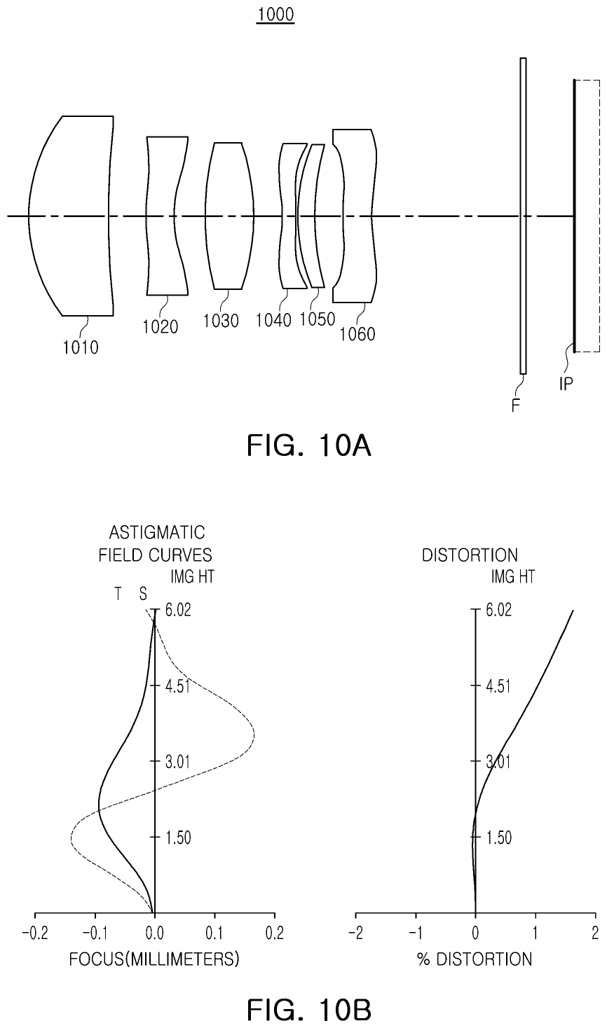

FIG. 10A is a configuration diagram illustrating an optical imaging system according to a tenth embodiment. FIG. 10B is a graph indicating aberration properties of an optical imaging system according to a tenth embodiment.

According to the tenth embodiment, an optical imaging system 1000 may include a first lens 1010, a second lens 1020, a third lens 1030, a fourth lens 1040, a fifth lens 1050, and a sixth lens 1060 disposed in order from an object side, and may further include an infrared cut-off filter F and an image sensor IP disposed on an image side of the sixth lens 1060. Also, the optical imaging system 1000 may further include an aperture ST disposed on an object side of the third lens 1030.

The first lens 1010 may have positive refractive power. An object-side surface of the first lens 1010 may be convex in a paraxial region, and an image-side surface of the first lens 1010 may be concave in the paraxial region. The first lens 1010 may be formed of a (low dispersion) glass material. Also, the first lens 1010 may be a spherical lens. For example, an object-side surface and an image-side surface of the first lens 1010 may be spherical.

The second lens 1020 may have negative refractive power. An object-side surface of the second lens 1020 may be convex in a paraxial region, and an image-side surface of the second lens 1020 may be concave in the paraxial region. The second lens 1020 may be formed of a plastic material. Accordingly, the second lens 1020 may have different optical properties (e.g., a different refractive index and a different Abbe number) from those of the first lens 1010. Also, the second lens 1020 may be an aspherical lens. For example, an object-side surface and an image-side surface of the second lens 1020 may be aspherical.

The third lens 1030 may have positive refractive power. Both an object-side surface and an image-side surface of the third lens 1030 may be convex in a paraxial region. The third lens 1030 may be formed of a plastic material. For example, the third lens 1030 may be formed of a plastic material having different optical properties (e.g., a different refractive index and a different Abbe number) from those of the second lens 1020, and may be formed of a plastic material having an Abbe number higher than that of the second lens 1020. Also, the third lens 1030 may be an aspherical lens. For example, an object-side surface and an image-side surface of the third lens 1030 may be aspherical.

The fourth lens 1040 may have negative refractive power. An object-side surface of the fourth lens 1040 may be concave in a paraxial region, and an image-side surface of the fourth lens 1040 may be convex in the paraxial region. The fourth lens 1040 may be formed of a plastic material. For example, the fourth lens 1040 may be formed of a plastic material having optical properties the same as or similar to (e.g., the same or a similar refractive index and Abbe number) those of the third lens 1030, and may be formed of a plastic material having an Abbe number higher than that of the fifth lens 1050. Also, the fourth lens 1040 may be an aspherical lens. For example, an object-side surface and an image-side surface of the fourth lens 1040 may be aspherical.

The fifth lens 1050 may have positive refractive power. An object-side surface of the fifth lens 1050 may be convex in a paraxial region, and an image-side surface of the fifth lens 1050 may be concave in the paraxial region. The fifth lens 1050 may be formed of a plastic material. For example, the fifth lens 1050 may be formed of a plastic material having different optical properties (e.g., a different refractive index and a different Abbe number) from those of the fourth lens 1040. Also, the fifth lens 1050 may be an aspherical lens. For example, an object-side surface and an image-side surface of the fifth lens 1050 may be aspherical.

The sixth lens 1060 may have negative refractive power. An object-side surface of the sixth lens 1060 may be convex in a paraxial region, and an image-side surface of the sixth lens 1060 may be concave in the paraxial region. The sixth lens 1060 may be formed of a plastic material. For example, the sixth lens 1060 may be formed of a plastic material having different optical properties (e.g., a different refractive index and a different Abbe number) from those of the fifth lens 1050. Also, the sixth lens 1060 may be an aspherical lens. For example, an object-side surface and an image-side surface of the sixth lens 1060 may be aspherical.

According to the tenth embodiment, the optical imaging system 1000 may include a first lens group LG1 including the first lens 1010, the second lens 1020 and the third lens 1030, and a second lens group LG2 including the fourth lens 1040, the fifth lens 1050 and the sixth lens 1060. The second lens group LG2 may move toward the image plane IP side when obtaining an image of a subject disposed at an ultra-short distance.

Table 19 below indicates optical and physical parameters of the optical imaging system 1000 according to the tenth embodiment.

TABLE 19

| | Radius of | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 7.6718 | 3.3504 | 1.4970 | 81.61 | 4.40 |
| 3 | 40.2665 | 1.5979 | | | 3.92 |
| 4 | 13.8055 | 1.1497 | 1.6144 | 25.94 | 3.52 |
| 5 | 5.2969 | 1.3020 | | | 3.33 |
| 6 | 9.9966 | 2.0000 | 1.5349 | 55.74 | 3.24 |
| 7 | −11.7696 | D1 | | | 3.20 |
| 8 | −6.6571 | 0.5786 | 1.5440 | 55.99 | 3.23 |
| 9 | −16.4245 | 0.0802 | | | 3.15 |
| 10 | 7.1961 | 0.7307 | 1.6608 | 20.38 | 3.18 |
| 11 | 8.2672 | 1.1646 | | | 3.16 |
| 12 | 12.4860 | 1.1959 | 1.5349 | 55.74 | 3.22 |
| 13 | 6.7713 | D2 | | | 3.85 |
| 14 | Infinity | 0.2100 | 1.5168 | 64.20 | 7.00 |
| 15 | Infinity | 2.0526 | | | 7.00 |
| Image | Infinity | | | | |

Table 20 below indicates aspherical data of the optical imaging system 1000 according to the tenth embodiment.

TABLE 20

| Surface | 2 | 3 | 4 | 5 | 6 | 7 |
|---|---|---|---|---|---|---|
| K | 0.00E+00 | 0.00E+00 | −2.83E+01 | −8.67E+00 | −1.04E+01 | 4.80E−01 |
| A | 0.00E+00 | 0.00E+00 | −3.45E−03 | 1.23E−03 | 7.30E−04 | −6.71E−04 |
| B | 0.00E+00 | 0.00E+00 | 5.66E−04 | −5.94E−04 | −5.32E−04 | 8.25E−04 |
| C | 0.00E+00 | 0.00E+00 | −2.72E−04 | 8.48E−05 | 4.43E−04 | −4.48E−04 |
| D | 0.00E+00 | 0.00E+00 | 9.10E−05 | −1.24E−05 | −2.44E−04 | 1.46E−04 |
| E | 0.00E+00 | 0.00E+00 | −2.02E−05 | 2.37E−06 | 8.21E−05 | −3.03E−05 |
| F | 0.00E+00 | 0.00E+00 | 3.10E−06 | −3.85E−07 | −1.79E−05 | 3.93E−06 |
| G | 0.00E+00 | 0.00E+00 | −3.30E−07 | 4.09E−08 | 2.60E−06 | −2.88E−07 |
| H | 0.00E+00 | 0.00E+00 | 2.38E−08 | −2.68E−09 | −2.50E−07 | 6.49E−09 |
| J | 0.00E+00 | 0.00E+00 | −1.11E−09 | 1.08E−10 | 1.53E−08 | 6.62E−10 |
| L | 0.00E+00 | 0.00E+00 | 3.01E−11 | −2.69E−12 | −5.38E−10 | −5.47E−11 |
| M | 0.00E+00 | 0.00E+00 | −3.59E−13 | 3.55E−14 | 8.29E−12 | 1.26E−12 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |
| Surface | 8 | 9 | 10 | 11 | 12 | 13 |
| K | −8.00E+00 | 1.77E+01 | −2.24E+00 | −7.70E+00 | 5.76E−01 | −2.17E+00 |
| A | 1.05E−02 | 8.38E−03 | −7.40E−03 | −6.18E−03 | −9.35E−03 | −9.29E−03 |
| B | 6.10E−03 | 2.59E−02 | 1.84E−02 | 5.63E−03 | −1.80E−03 | 9.39E−04 |
| C | −6.84E−03 | −2.69E−02 | −1.72E−02 | −3.93E−03 | 2.05E−03 | −2.45E−04 |
| D | 3.51E−03 | 1.42E−02 | 8.68E−03 | 1.64E−03 | −1.15E−03 | 7.93E−05 |
| E | −1.12E−03 | −4.67E−03 | −2.72E−03 | −4.24E−04 | 4.09E−04 | −1.85E−05 |
| F | 2.35E−04 | 1.01E−03 | 5.58E−04 | 6.68E−05 | −9.70E−05 | 2.89E−06 |
| G | −3.34E−05 | −1.48E−04 | −7.62E−05 | −5.85E−06 | 1.54E−05 | −2.98E−07 |
| H | 3.17E−06 | 1.43E−05 | 6.87E−06 | 1.60E−07 | −1.61E−06 | 2.01E−08 |
| J | −1.91E−07 | −8.79E−07 | −3.91E−07 | 1.70E−08 | 1.06E−07 | −8.50E−10 |
| L | 6.68E−09 | 3.12E−08 | 1.27E−08 | −1.62E−09 | −4.02E−09 | 2.04E−11 |
| M | −1.02E−10 | −4.87E−10 | −1.80E−10 | 4.18E−11 | 6.64E−11 | −2.12E−13 |
| N | 0.00E+00 | 0.00E+00 | 0.00E+00 | 0.00E+00 | 0.00E+00 | 0.00E+00 |
| O | 0.00E+00 | 0.00E+00 | 0.00E+00 | 0.00E+00 | 0.00E+00 | 0.00E+00 |
| P | 0.00E+00 | 0.00E+00 | 0.00E+00 | 0.00E+00 | 0.00E+00 | 0.00E+00 |

Table 21 below indicates distance change (AF stroke) during focusing of the optical imaging system according to embodiments.

TABLE 21

| | | Embodiment | Embodiment | Embodiment | Embodiment | Embodiment |
|---|---|---|---|---|---|---|
| | | 1 | 2 | 3 | 4 | 5 |
| D1 | Infinity | 1.2000 | 1.2000 | 1.2000 | 0.9000 | 0.8600 |
| | Macro | 3.6225 | 3.9000 | 3.8645 | 3.3444 | 3.6600 |
| D2 | Infinity | 7.1451 | 6.8676 | 6.2106 | 6.2112 | 6.9477 |
| | Macro | 4.7226 | 4.1676 | 3.5461 | 3.7669 | 4.1477 |
| | | Embodiment | Embodiment | Embodiment | Embodiment | Embodiment |
| | | 6 | 7 | 8 | 9 | 10 |
| D1 | Infinity | 1.0000 | 1.2000 | 1.0000 | 1.3500 | 1.2000 |
| | Macro | 3.9641 | 3.8519 | 3.7843 | 4.3500 | 3.9000 |
| D2 | Infinity | 6.2104 | 6.2106 | 6.2105 | 6.2105 | 6.2106 |
| | Macro | 3.2463 | 3.5587 | 3.4262 | 3.2105 | 3.5106 |

Table 22 below indicates optical and physical parameters related to focal lengths and conditional expressions of the optical imaging system according to embodiments.

TABLE 22

| | Embodiment 1 | Embodiment 2 | Embodiment 3 | Embodiment 4 | Embodiment 5 |
|---|---|---|---|---|---|
| f | 22.482 | 22.485 | 22.486 | 22.486 | 22.486 |
| f1 | 21.602 | 20.338 | 22.621 | 15.202 | 18.756 |
| f2 | −14.773 | −13.263 | −13.532 | −16.145 | −15.154 |
| f3 | 9.913 | 9.190 | 8.864 | 12.837 | 10.558 |
| f4 | −12.721 | −16.153 | −20.078 | −22.029 | −14.509 |
| f5 | 59.901 | 52.843 | 50.365 | 23.982 | 27.835 |
| f6 | −254.689 | −45.467 | −25.981 | −17.454 | −31.677 |
| fG1 | 13.302 | 13.715 | 13.671 | 13.323 | 13.811 |
| fG2 | −13.272 | −13.905 | −13.553 | −15.786 | −14.394 |
| TTL | 23.000 | 23.000 | 23.000 | 23.005 | 22.921 |
| BFL | 8.355 | 8.400 | 8.400 | 7.764 | 8.551 |
| Fno | 2.550 | 2.555 | 2.555 | 2.530 | 2.526 |
| ImgHT | 5.72 | 5.72 | 5.72 | 5.72 | 5.72 |
| FOV | 28.150 | 28.142 | 28.131 | 28.132 | 28.131 |
| EPD | 8.800 | 8.802 | 8.802 | 8.900 | 8.902 |
| SDG2 | 3.54 | 3.80 | 3.80 | 3.80 | 3.51 |
| ΣCTG1 | 6.328 | 5.640 | 6.010 | 6.239 | 5.186 |
| StrokeG2 | 2.4225 | 2.7000 | 2.6645 | 2.4444 | 2.8000 |
| | Embodiment 6 | Embodiment 7 | Embodiment 8 | Embodiment 9 | Embodiment 10 |
| f | 22.487 | 22.486 | 22.486 | 22.491 | 22.484 |
| f1 | 15.309 | 22.614 | 16.311 | 16.840 | 18.440 |
| f2 | −17.950 | −13.511 | −18.459 | −18.935 | −14.747 |
| f3 | 14.833 | 8.836 | 13.207 | 13.393 | 10.440 |
| f4 | −22.134 | −19.088 | −41.182 | −43.239 | −21.016 |
| f5 | 18.336 | 49.608 | 13.275 | 18.287 | 66.112 |
| f6 | −16.706 | −27.930 | −8.679 | −10.082 | −29.834 |
| fG1 | 14.078 | 13.652 | 13.723 | 13.966 | 13.708 |
| fG2 | −19.992 | −13.563 | −14.894 | −14.547 | −14.092 |
| TTL | 23.000 | 23.000 | 23.000 | 22.797 | 22.823 |
| BFL | 10.064 | 8.400 | 8.099 | 8.093 | 8.473 |
| Fno | 2.526 | 2.555 | 2.526 | 2.526 | 2.555 |
| ImgHT | 5.72 | 5.72 | 5.72 | 5.72 | 5.72 |
| FOV | 28.132 | 28.131 | 28.135 | 28.127 | 28.131 |
| EPD | 8.903 | 8.802 | 8.902 | 8.904 | 8.801 |
| SDG2 | 3.43 | 3.80 | 3.59 | 3.90 | 3.85 |
| ΣCTG1 | 5.209 | 6.071 | 6.025 | 5.977 | 6.500 |
| StrokeG2 | 2.9641 | 2.6519 | 2.7843 | 3.0000 | 2.7000 |

The optical imaging system according to the embodiments described above may be slimmed as compared to the size of the image sensor.

According to the aforementioned embodiments, the optical imaging system may obtain an image at an ultra-short distance and may ensure uniform resolution without being affected by a focal length.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens group including a first lens, a second lens, and a third lens; and
a second lens group including a fourth lens, a fifth lens, and a sixth lens and configured to be movable in an optical axis direction,
wherein the first lens group and the second lens group are disposed in order from an object side toward an image plane side, and
wherein conditional expression 1.50<(v1−v2)/(v3−v2)<2.50 is satisfied,
where v1 is an Abbe number of the first lens, v2 is an Abbe number of the second lens, and v3 is an Abbe number of the third lens.

2. The optical imaging system of claim 1,
wherein the first lens is formed of a glass material,
wherein the first lens has positive refractive power, and
wherein the second lens has negative refractive power.

3. The optical imaging system of claim 1, wherein the third lens has positive refractive power, and
wherein both an object-side surface and an image-side surface of the third lens are convex.

4. The optical imaging system of claim 1, wherein conditional expression −1.50<f2/fG1<−0.85 is satisfied,
where f2 is a focal length of the second lens, and fG1 is a focal length of the first lens group.

5. The optical imaging system of claim 1, wherein conditional expression 0.38<CT1/ΣCTG1≤0.60 is satisfied,
where CT1 is a central thickness of the first lens, and ΣCTG1 is a sum of central thicknesses of the lenses included in the first lens group.

6. The optical imaging system of claim 1, wherein conditional expression 2.00<Fno≤2.60 is satisfied,
where Fno is an f value of the optical imaging system.

7. The optical imaging system of claim 1, wherein the fourth lens has negative refractive power and a convex object-side surface.

8. The optical imaging system of claim 1, wherein the fifth lens has positive refractive power, and
wherein the sixth lens has negative refractive power.

9. The optical imaging system of claim 1, wherein conditional expression 0.30≤v5/v6<1.20 is satisfied,
where v5 is an Abbe number of the fifth lens, and v6 is an Abbe number of the sixth lens.

10. The optical imaging system of claim 1, wherein conditional expression 0.35<EPD/TTL ≤0.40 is satisfied,
where EPD is an entrance pupil diameter of the optical imaging system, and TTL is a distance on the optical axis from an object-side surface of the first lens to the image plane.

11. An optical imaging system, comprising:
a first lens group including a plurality of lenses and disposed fixedly on an optical axis; and
a second lens group including a plurality of lenses and configured to be movable in an optical axis direction between the first lens group and an image plane,
wherein the first lens group and the second lens group are disposed in order from an object side toward the image plane side,
wherein conditional expression 0.35<EPD/TTL≤0.40 is satisfied,
where EPD is an entrance pupil diameter of the optical imaging system, and TTL is a distance on the optical axis from an object-side surface of a lens disposed closest to the object side among the plurality of lenses to the image plane.

12. The optical imaging system of claim 11, wherein the first lens group has positive refractive power, and
wherein the second lens group has negative refractive power.

13. The optical imaging system of claim 11, wherein the first lens group includes a lens formed of a glass material.

14. The optical imaging system of claim 11, wherein conditional expression 0.95≤TTL/f<1.10 is satisfied,
where TTL is a distance on the optical axis from an object-side surface of a lens disposed closest to the object side to the image plane, and f is a focal length of the optical imaging system.

15. The optical imaging system of claim 11, wherein conditional expression 0.30<BFL/f <0.50 is satisfied,
where BFL is a distance on the optical axis from an image-side surface of a lens disposed closest to the image side to the image plane, and f is a focal length of the optical imaging system.

16. The optical imaging system of claim 11,
wherein the first lens group includes a first lens having positive refractive power, a second lens having negative refractive power, and a third lens having positive refractive power, and
wherein the second lens group includes a fourth lens having negative refractive power, a fifth lens having positive refractive power, and a sixth lens having negative refractive power.

17. An optical imaging system, comprising:
a first lens group including a first lens, a second lens, and a third lens; and
a second lens group including a fourth lens, a fifth lens, and a sixth lens and configured to be movable in an optical axis direction,
wherein the first lens group and the second lens group are disposed in order from an object side toward an image plane,
wherein conditional expressions 0.30<BFL/f<0.50, and 2.00<Fno≤2.60 are satisfied,
where BFL is a distance on the optical axis from an image-side surface of the sixth lens to the image plane, f is a focal length of the optical imaging system, and Fno is an f value of the optical imaging system.

18. The optical imaging system of claim 17,
wherein conditional expression −1.50<f2/fG1<−0.85 is satisfied,
where f2 is a focal length of the second lens, and fG1 is a focal length of the first lens group.
